(19) United States
(12) Patent Application Publication
(10) Pub. No.: US 2021/0065081 A1
(43) Pub. Date: Mar. 4, 2021

(54) COMPUTER SYSTEM AND WORK SUPPORT METHOD

(71) Applicant: HITACHI, LTD., Tokyo (JP)

(72) Inventors: Yuusuke MORITA, Tokyo (JP); Tooru SHIMOTORI, Tokyo (JP)

(73) Assignee: HITACHI, LTD., Tokyo (JP)

(21) Appl. No.: 16/813,876

(22) Filed: Mar. 10, 2020

(30) Foreign Application Priority Data
Aug. 26, 2019 (JP) 2019-153843

(51) Int. Cl. G06Q 10/06

(52) U.S. Cl. CPC G06Q 10/06311

(57) ABSTRACT

A computer system, which is configured to support a work formed of a combination of tasks, manages work management information for storing logs each including identification information on a work, an object of the work, a combination of tasks for the work, and evaluation information indicating an evaluation obtained by a user for a result of the work. The computer system obtains, in a case where a new work is to be executed, logs including the same object as an object of the new work; calculates an evaluation value of the work corresponding to the logs based on the evaluation information included in the logs; selects a combination of tasks recommended for the new work from among combinations of tasks included in the logs, based on the first evaluation value; and presents the selected combination of tasks to a user of the new work.

### CLAIM OF PRIORITY

The present application claims priority from Japanese patent application JP 2019-153843 filed on Aug. 26, 2019, the content of which is hereby incorporated by reference into this application.

### BACKGROUND OF THE INVENTION

This invention relates to a technology for supporting an analysis work. A data analysis using big data has been actively employed by a large number of corporations as being essential for planning business management strategies and improving business performance. However, there are few people capable of performing the data analysis using big data, which is complicated and difficult.

Therefore, in spite of being aware of the importance of the data analysis, corporations may fail to effectively utilize data because of being unable to secure human resources for the data analysis.

In addition, there are a wide variety of tools and methods to be used for a data analysis and a wide variety of combinations of parameters to be set therefor, and hence it requires high cost to pass on and acquire know-how on the data analysis.

In view of the foregoing, systems utilizing the knowledge of skilled engineers have been attracting attention (see, for example, JP 2005-316641 A). In JP 2005-316641 A, the following is described: “A design work is stored in a database in the form of a data table (DT). The DT of a connection design work is provided with a self-ID and a name. The DT of the unit design work is provided with not only the self-ID but also the ID and classification code of the connection design work, and provided with its self name, the ID of a unit design work to be performed prior to itself, the ID of the unit design work to be performed after itself, the arbitrary number of sets of attributes about itself and its values, the ID of object attributes being reference items and the ID of the object items being design items. The DT of the design object is provided with self-ID and name and classification codes. Also, the DT of the object attributes is provided with self-ID and names and values and the ID of the object attributes. The DT of a product is provided with self-ID and names and the ID of the unit design work. The DT having the ID is newly prepared, registered and edited so that the details of the connection design work can be stored in the database.”

### SUMMARY OF THE INVENTION

The technology described in JP 2005-316641 A is based on the premise that there is an optimal work procedure for one work object on a one-to-one basis. Meanwhile, in a data analysis, there are various combinations of objects and tasks to be executed. Therefore, when the technology described in JP 2005-316641 A is used, appropriate information cannot be presented, and the amount of information to be presented is enormous.

This invention achieves a system configured to support, when a new analysis work is to be executed, the analysis work by presenting useful information from logs of analysis works, and a method therefor.

A representative example of the present invention disclosed in this specification is as follows: a computer system, which is configured to support a work formed of a combination of a plurality of tasks so as to be executed in order to achieve a predetermined object, comprises at least one computer including: a processor; and a storage device coupled to the processor. The computer system is configured to manage work management information for storing a plurality of logs each including identification information on a work, an object of the work, a combination of tasks for the work, and evaluation information indicating an evaluation obtained by a user for a result of the work. The at least one computer is configured to: obtain, in a case where a new work is to be executed, at least one of the plurality of logs including the same object as an object of the new work; calculate a first evaluation value of the work corresponding to the at least one of the plurality of logs based on the evaluation information included in the at least one of the plurality of logs; select a combination of tasks recommended for the new work from among combinations of tasks included in the at least one of the plurality of logs, based on the first evaluation value; and present the selected combination of tasks to a user of the new work.

According to at least one embodiment of this invention, when a new analysis work is to be executed, it is possible to support the analysis work by presenting useful information from logs of past analysis works. Other problems, configurations, and effects than those described above will become apparent in the descriptions of embodiments below.

### BRIEF DESCRIPTION OF THE DRAWINGS

The present invention can be appreciated by the description which follows in conjunction with the following figures, wherein:

FIG. 1 is a diagram for illustrating an example of a hardware configuration and a software configuration of a computer in a first embodiment of this invention;

FIG. 2 is a table for showing an example of the data structure of analyst management information in the first embodiment;

FIG. 3A and FIG. 3B are tables for showing examples of the data structure of object management information in the first embodiment;

FIG. 4 is a table for showing an example of the data structure of work management information in the first embodiment;

FIG. 5 is a table for showing an example of the data structure of task management information in the first embodiment;

FIG. 6 is a table for showing an example of the data structure of task detail management information in the first embodiment;

FIG. 7 is a table for showing an example of the data structure of operation log management information in the first embodiment;

FIG. 8 is a flow chart for illustrating an example of processing to be executed by an analysis work support module in the first embodiment;

FIG. 9 is a flow chart for illustrating an example of processing to be executed by a main processing module in the first embodiment;

FIG. 10 is a flow chart for illustrating an example of processing to be executed by a work management module in the first embodiment;

FIG. 11 is a flow chart for illustrating an example of processing to be executed by a task management module in the first embodiment;

FIG. 12A and FIG. 12B are diagrams for illustrating examples of the UI to be displayed by the main processing module in the first embodiment;

FIG. 13 is a flow chart for illustrating an example of processing to be executed by a work search module in the first embodiment;

FIG. 14 is a flow chart for illustrating an example of processing to be executed by an evaluation module in the first embodiment;

FIG. 15A, FIG. 15B, FIG. 15C, and FIG. 15D are diagrams for describing the concept of the processing executed by the evaluation module in the first embodiment;

FIG. 16 is a flow chart for illustrating an example of processing to be executed by a pre-processing module in the first embodiment;

FIG. 17 is a diagram for illustrating an example of a hardware configuration and a software configuration of the computer in the second embodiment;

FIG. 18 is a table for showing an example of the data structure of the task management information in the second embodiment;

FIG. 19 is a flow chart for illustrating an example of processing to be executed by the main processing module in the second embodiment;

FIG. 20 is a flow chart for illustrating an example of processing to be executed by the work search module in the second embodiment;

FIG. 21 is a flow chart for illustrating an example of processing to be executed by the main processing module in the third embodiment; and

FIG. 22 is a flow chart for illustrating an example of processing to be executed by the work search module in the third embodiment.

### DETAILED DESCRIPTION OF THE PREFERRED EMBODIMENTS

Now, a description is given of an embodiment of this invention referring to the drawings. It should be noted that this invention is not to be construed by limiting the invention to the content described in the following embodiment. A person skilled in the art would easily recognize that a specific configuration described in the following embodiment may be changed within the scope of the concept and the gist of this invention.

In a configuration of this invention described below, the same or similar components or functions are assigned with the same reference numerals, and a redundant description thereof is omitted here.

Notations of, for example, “first”, “second”, and “third” herein are assigned to distinguish between components, and do not necessarily limit the number or order of those components.

### First Embodiment

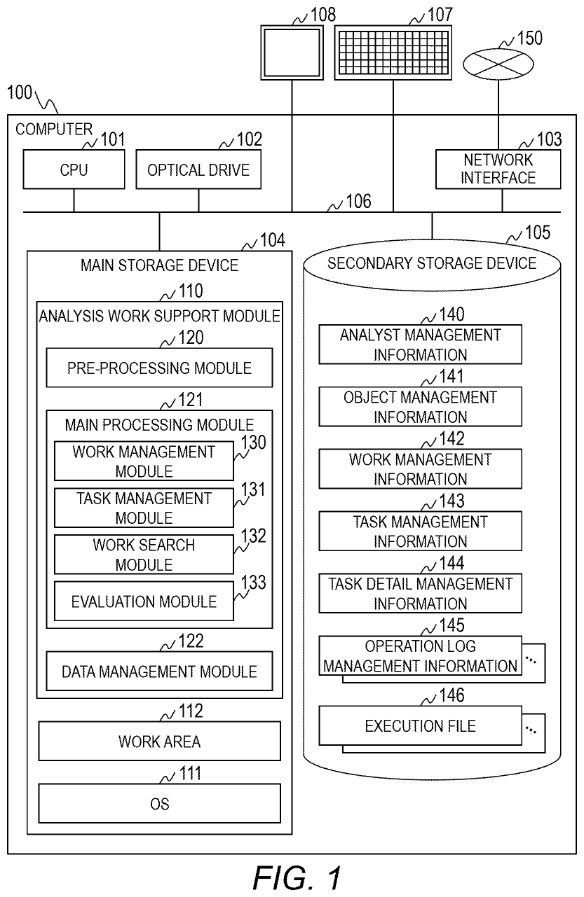

FIG. 1 is a diagram for illustrating an example of a hardware configuration and a software configuration of a computer 100 in a first embodiment of this invention.

The computer 100 presents, when a new analysis work is to be executed, a combination of tasks associated with a log that satisfies a predetermined criterion from among logs of analysis works, as recommendation information for determining a combination of tasks for the new analysis work. The same function may be implemented through use of a computer system including a plurality of computers 100.

The analysis work relates to a data analysis to be executed by an analyst in order to achieve a predetermined object. The analysis work is achieved by executing a plurality of tasks in accordance with a procedure. Conceivable examples thereof include an analysis work that includes executing tasks in the order of a data processing task, an analysis task using a service or a tool, and a task of organizing or formatting data.

The computer 100 includes a CPU 101, an optical drive 102, a network interface 103, a main storage device 104, and a secondary storage device 105. The above-mentioned hardware components are coupled to one another through an internal bus 106. In addition, an input apparatus 107 and an output apparatus 108 are coupled to the computer 100. Examples of the input apparatus 107 include a keyboard, a mouse, and a touch panel, and examples of the output apparatus 108 include a display and a printer.

The CPU 101 executes a program stored in the main storage device 104. The CPU 101 operates as a function module configured to implement a specific function by executing processing as programmed by the program. In the following description, a sentence describing processing with a function module as the subject of the sentence means that a program for implementing the function module is executed by the CPU 101.

The optical drive 102 is a drive configured to execute write processing and read processing on an optical disc. The network interface 103 is an interface for communicating to/from an external apparatus through a network 150.

The network 150 is, for example, a local area network (LAN) and a wide area network (WAN). This invention is not limited to the type and coupling method of the network 150.

The main storage device 104 is a memory or another such storage device, and stores programs to be executed by the CPU 101 and information to be used by the programs. The main storage device 104 includes a work area 112 to be used temporarily by the programs. The secondary storage device 105 is a storage device, such as a hard disk drive (HDD) and a solid state drive (SSD), and stores data permanently.

First, a description is given of information stored in the secondary storage device 105. The secondary storage device 105 stores analyst management information 140, object management information 141, work management information 142, task management information 143, task detail management information 144, operation log management information 145, and an execution file 146. The above-mentioned information may be stored in a storage apparatus and a storage system that are accessible to the computer 100. The storage apparatus and the storage system may be provided by a cloud service.

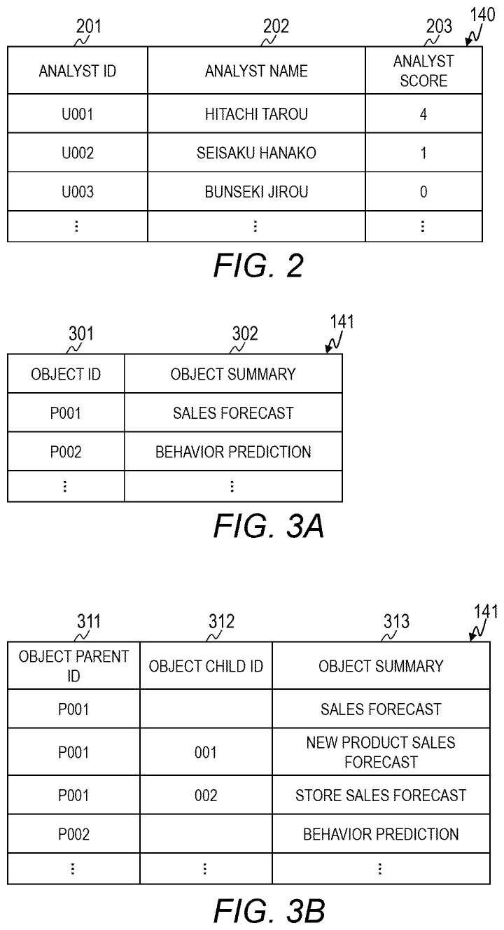

The analyst management information 140 is information for managing an analyst (user). Details of the data structure of the analyst management information 140 are described later with reference to FIG. 2.

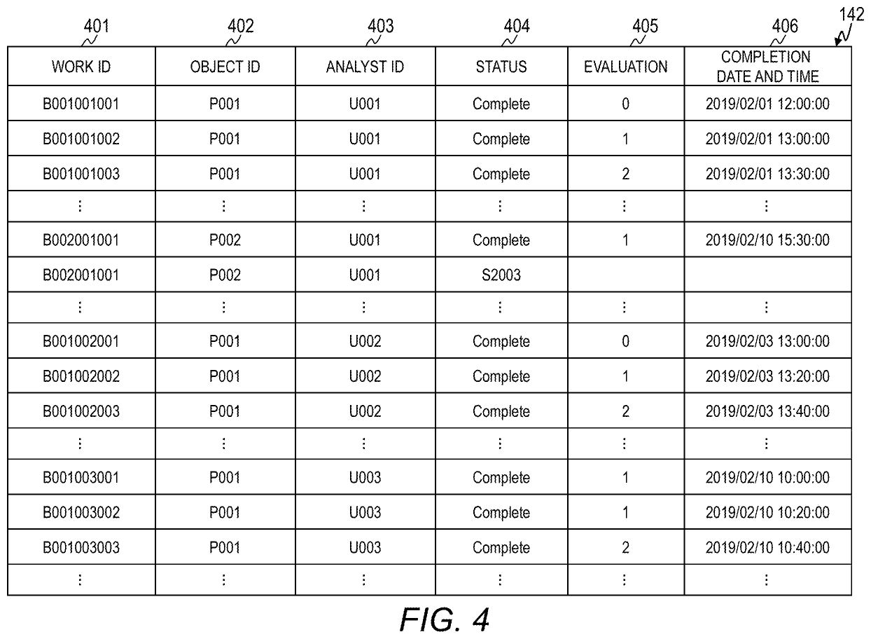

The object management information 141 is information for managing the object of an analysis work. Details of the data structure of the object management information 141 are described later with reference to FIG. 3A and

FIG. 3B.

The work management information 142 is information for managing analysis works. Data stored in the work management information 142 corresponds to logs of the analysis works. Details of the data structure of the work management information 142 are described later with reference to FIG. 4.

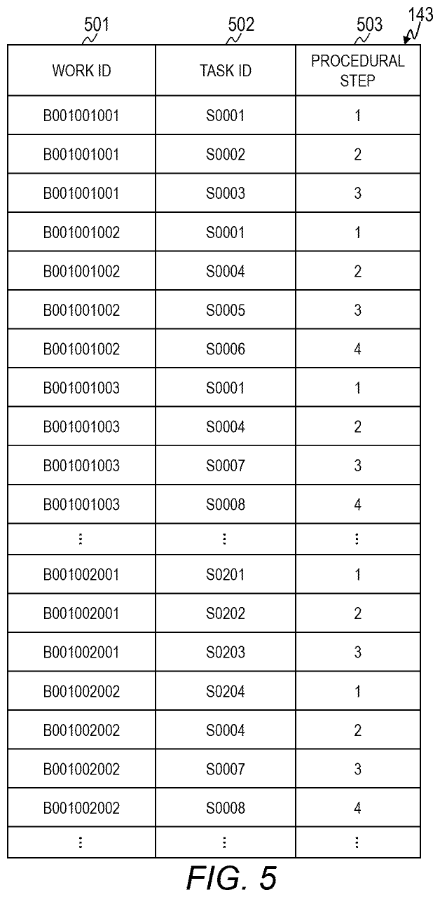

The task management information 143 is information for managing a combination of tasks for the analysis work. In this case, the combination of tasks is a concept including the execution order of the tasks. Details of the data structure of the task management information 143 are described later with reference to FIG. 5.

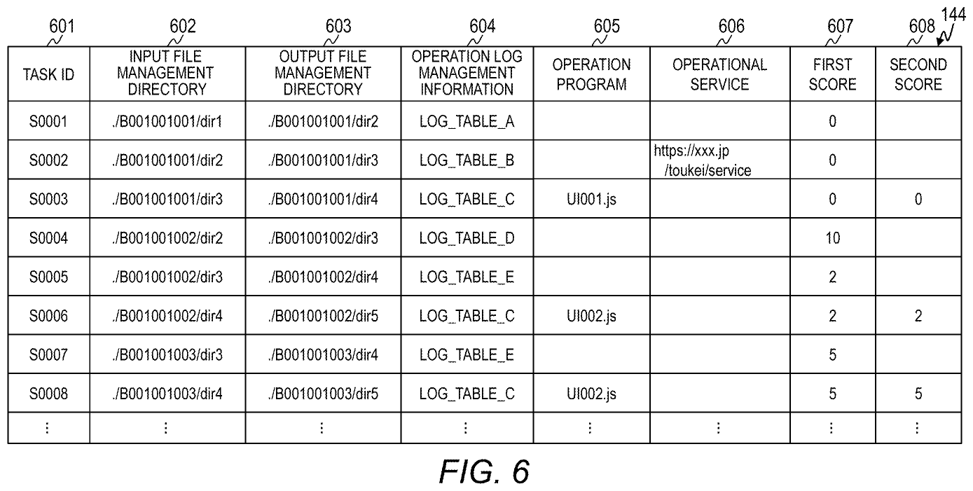

The task detail management information 144 is information for managing details of each individual task. Details of the data structure of the task detail management information 144 are described later with reference to FIG. 6.

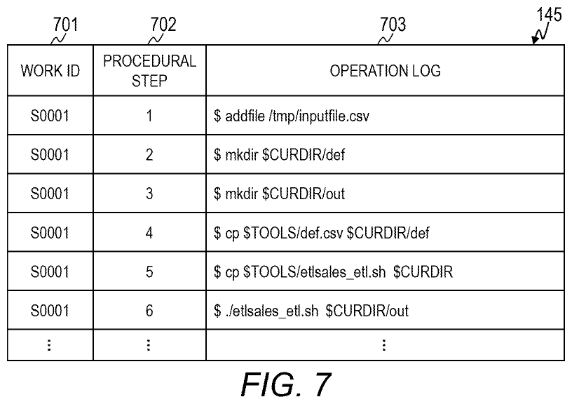

The operation log management information 145 is information for managing a log of operations performed in one task. Details of the data structure of the operation log management information 145 are described later with reference to FIG. 7. One piece of operation log management information 145 may be provided for a plurality of tasks.

The execution file 146 is information that defines processing and a tool to be used for the task, and examples thereof include an analysis program originally developed by the analyst, a batch file for executing ELT processing, and a shell script.

In regard to microservices and applications that can be used when a task is executed, a system administrator (or system developer) sets methods of obtaining and managing operation logs, and registers the methods in the execution file 146 in advance. The analyst performs the task through use of the registered microservices and applications.

It should be noted that a file obtained by packaging a plurality of files may be set as the execution file 146. In this case, it is required to provide an execution environment for the execution file 146 in advance.

Next, a description is given of programs stored in the main storage device 104. The main storage device 104 stores programs for implementing an analysis work support module 110 and an OS 111.

The OS 111 controls the entire computer 100. The analysis work support module 110 manages logs relating to an analysis work, and supports the analysis work through use of the logs. The OS 111 may have the functions of the analysis work support module 110.

The analysis work support module 110 includes a pre-processing module 120, a main processing module 121, and a data management module 122.

The pre-processing module 120 registers the execution file 146 to be executed in one task for the analysis work. The data management module 122 includes a file system for storing data, a DBMS, and an API for a cloud storage, for example, and controls reading and writing of data based on requests received from other functional modules.

The main processing module 121 supports an analysis work. Specifically, the main processing module 121 presents a recommended combination of tasks when a new analysis work is to be executed. The main processing module 121 includes a work management module 130, a task management module 131, a work search module 132, and an evaluation module 133. The functional modules included in the main processing module 121 may have a plurality of functional modules combined into one functional module, or may have one functional module divided into a plurality of functional modules on a function-to-function basis.

The work management module 130 manages the execution of an analysis work. The task management module 131 controls the execution of each task for the analysis work. The work search module 132 searches for a recommended combination of tasks (log of the analysis work). The evaluation module 133 calculates an evaluation value relating to the analysis work.

Next, the data structures of information held by the computer 100 are described with reference to FIG. 2 to FIG. 7.

FIG. 2 is a table for showing an example of the data structure of the analyst management information 140 in the first embodiment.

The analyst management information 140 stores an entry including an analyst ID 201, an analyst name 202, and an analyst score 203. There is one entry for one analyst.

The analyst ID 201 is a field for storing identification information for uniquely identifying an analyst (user). The analyst name 202 is a field for storing the name of the analyst.

The analyst score 203 is a field for storing an evaluation value representing a quantitative evaluation obtained by the analyst who has executed the analysis work. The evaluation value may be stored for each object of the analysis work executed by the analyst.

FIG. 3A and FIG. 3B are tables for showing examples of the data structure of the object management information 141 in the first embodiment. FIG. 3A and FIG. 3B each show the object management information 141 having a different data structure.

The object management information 141 shown in FIG. 3A stores an entry including an object ID 301 and an object summary 302. There is one entry for one object of the analysis work.

The object ID 301 is a field for storing identification information for uniquely identifying the object of the analysis work. The object summary 302 is a field for storing information including a character string indicating the object of the analysis work.

The object management information 141 shown in FIG. 3B is different from the object management information 141 shown in FIG. 3A in that the object management information 141 shown in FIG. 3B manages analysis objects in a hierarchical manner. In this case, it is assumed that the analysis object is represented by two tiers of a main category and a subcategory. The object management information 141 shown in FIG. 3B stores an entry including an object parent ID 311, an object child ID 312, and an object summary 313. There is one entry for one object of the analysis work.

The object parent ID 311 is a field for storing identification information for uniquely identifying the main category of the object of the analysis work. The object child ID 312 is a field for storing identification information for uniquely identifying the subcategory for the object of the analysis work. The object child ID 312 of the entry corresponding to the main category of the analysis work is blank. The object summary 313 is a field for storing information including a character string indicating the object of the analysis work.

In this specification, the data structure of the object management information 141 shown in FIG. 3A is employed.

FIG. 4 is a table for showing an example of the data structure of the work management information 142 in the first embodiment.

The work management information 142 stores an entry including a work ID 401, an object ID 402, an analyst ID 403, a status 404, an evaluation 405, and a completion date and time 406. There is one entry for one analysis work.

The work ID 401 is a field for storing identification information for uniquely identifying an analysis work.

The object ID 402 is a field for storing identification information on the object of the analysis work corresponding to the entry. The identification information stored in the object ID 402 is the same as the identification information stored in the object ID 301 of the object management information 141.

The analyst ID 403 is a field for storing identification information on the analyst who has executed the analysis work corresponding to the entry. The identification information stored in the analyst ID 403 is the same as the identification information stored in the analyst ID 201 of the analyst management information 140.

The status 404 is a field for storing information indicating the execution status of the analysis work corresponding to the entry. For example, “Complete” indicates that the analysis work has been completed. When the analysis work is running, the status 404 stores identification information on a running task. The above-mentioned information is merely an example, and this invention is not limited thereto.

The evaluation 405 is a field for storing information indicating an evaluation obtained by the analyst for a result of the analysis work corresponding to the entry. In the first embodiment, a numerical value of from “0” to “2” is stored. The value “0” represents the lowest evaluation, and the value “2” represents the highest evaluation. The above-mentioned information is merely an example, and this invention is not limited thereto. Any one of a quantitative evaluation and a qualitative evaluation may be used. As the qualitative evaluation, for example, symbols including “round” meaning “good”, “cross” meaning “bad”, and “triangle” meaning “average” may be used, or character strings including “excellent”, “good”, and “bad” may be used.

The completion date and time 406 is a field for storing the date and time at which the analysis work corresponding to the entry was completed.

FIG. 5 is a table for showing an example of the data structure of the task management information 143 in the first embodiment.

The task management information 143 stores an entry including a work ID 501, a task ID 502, and a procedural step 503. There is one entry for one combination of the work and the task.

The work ID 501 is a field for storing identification information for uniquely identifying an analysis work. The identification information stored in the work ID 501 is the same as the identification information stored in the work ID 401 of the work management information 142.

The task ID 502 is a field for storing identification information for uniquely identifying a task to be executed in the analysis work corresponding to the work ID 501. The identification information on the task is information assigned to each task. Therefore, when a task of the same content is executed in different analysis works, the same identification information is stored in the task ID 502 for the respective analysis works.

The procedural step 503 is a field for storing information indicating the execution order position of the task corresponding to the task ID 502 for the analysis work corresponding to the work ID 501.

FIG. 6 is a table for showing an example of the data structure of the task detail management information 144 in the first embodiment.

The task detail management information 144 stores an entry including a task ID 601, an input file management directory 602, an output file management directory 603, operation log management information 604, an operation program 605, an operational service 606, a first score 607, and a second score 608. There is one entry for one task.

The task ID 601 is a field for storing identification information for uniquely identifying a task. The identification information stored in the task ID 601 is the same as the identification information stored in the task ID 502 of the task management information 143.

The input file management directory 602 and the output file management directory 603 are fields for storing information on directories that are dynamically changed for each task. The input file management directory 602 and the output file management directory 603 store information on directories required to be replaced when a command in the operation log is executed in a case where the task is diverted. The information on the directories may be expressed by any one of absolute paths and relative paths.

The operation log management information 604 is a field for storing identification information on the operation log management information 145 for managing the log of an operation performed in the task.

The operation program 605 is a field for storing information relating to a program operated in the task. The operation program 605 stores, for example, the name of the program.

The operational service 606 is a field for storing information relating to, for example, an external service used in the task. The operational service 606 stores, for example, the name of an operational service and a URL for using the operational service.

The first score 607 is a field for storing a score representing a quantitative evaluation of the task corresponding to the task ID 601.

The second score 608 is a field for storing a score representing a quantitative evaluation of the result of the analysis work in which the task corresponding to the task ID 601 is the final task. The second score 608 stores a value calculated based on the evaluation obtained by the analyst for the result of the analysis work (that is, based on the evaluation 405). Only the second score 608 of the entry corresponding to the final task for the analysis work stores a value, and the second score 608 of another entry is blank.

FIG. 7 is a table for showing an example of the data structure of the operation log management information 145 in the first embodiment.

The operation log management information 145 stores an entry including a task ID 701, a procedural step 702, and an operation log 703. There is one entry for one operation.

The task ID 701 is a field for storing identification information for uniquely identifying a task for which an operation stored in the operation log 703 has been performed. The identification information stored in the task ID 701 is the same as the identification information stored in the task ID 502 of the task management information 143.

The procedural step 702 is a field for storing information indicating the execution order position of the operation stored in the operation log 703 for the task corresponding to the task ID 701.

The operation log 703 is a field for storing information indicating an operation executed in the task corresponding to the task ID 701. The operation log 703 stores, for example, a command input through use of a command line tool.

The various kinds of information described with reference to FIG. 2 to FIG. 7 may not be the information having a table format. For example, information having a text format, a CSV format, or an XML format may be used. For example, when the operation log management information 145 is held in a text format, the same information can be held by handling a file name as the task ID 701 and the description order position of the operation log as the procedural step 702.

Of the various kinds of information described with reference to FIG. 2 to FIG. 7, at least two pieces of information may be integrated to be managed as one piece of information. For example, the work management information 142 and the task management information 143 may be combined into one piece of information.

The data structures of the information held by the computer 100 have been described above. Next, processing to be executed by the computer 100 is described.

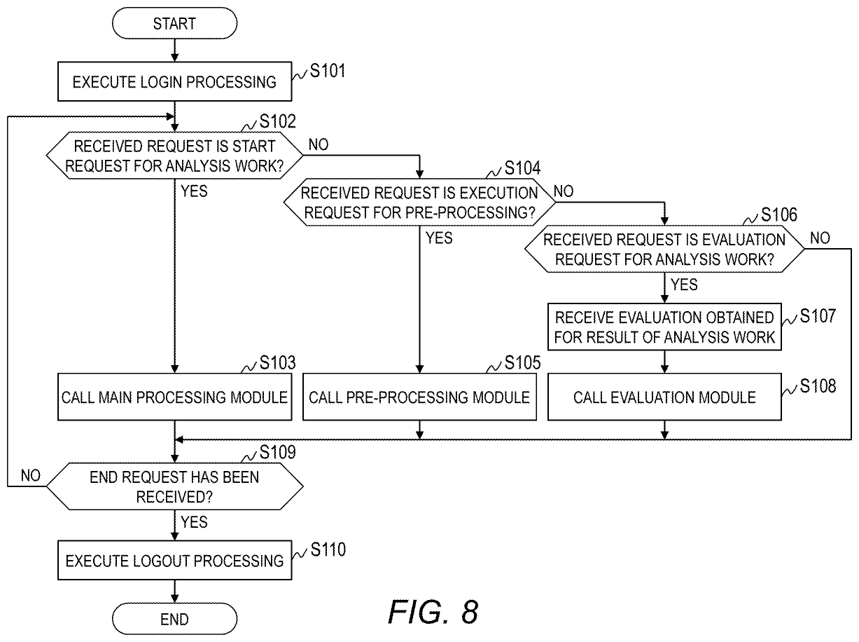

FIG. 8 is a flow chart for illustrating an example of processing to be executed by the analysis work support module 110 in the first embodiment.

In a case where the computer 100 receives access from an analyst, the computer 100 calls the analysis work support module 110. The called analysis work support module 110 starts the processing described with reference to FIG. 8.

The analysis work support module 110 provides a dedicated user interface (UI) to the analyst. The analyst uses the UI to input various requests to the computer 100.

First, the analysis work support module 110 executes login processing (Step S101). The login processing is a known technology, and hence its detailed description is omitted. At this time, the analysis work support module 110 stores the identification information on the analyst in the work area 112. The identification information on the analyst can be obtained from the analyst management information 140 based on, for example, a name input in the login processing. In the login processing, in a case where the identification information on the analyst is input, the relevant information is stored in the work area 112 as it is.

After the execution of the login processing, the analysis work support module 110 stands by for the input of a request to be performed by the analyst.

The analysis work support module 110 determines whether or not the received request is a start request for an analysis work (Step S102).

In a case of determining that the received request is the start request for the analysis work, the analysis work support module 110 calls the main processing module 121 (Step S103). After processing performed by the main processing module 121 is brought to an end, the analysis work support module 110 advances to Step S109.

In a case of determining that the received request is not the start request for the analysis work, the analysis work support module 110 determines whether or not the received request is an execution request for pre-processing (Step S104).

In a case of determining that the received request is the execution request for the pre-processing, the analysis work support module 110 calls the pre-processing module 120 (Step S105). After processing performed by the pre-processing module 120 is brought to an end, the analysis work support module 110 advances to Step S109.

In a case of determining that the received request is not the execution request for the pre-processing, the analysis work support module 110 determines whether or not the received request is an evaluation request for the analysis work (Step S106).

In a case of determining that the received request is not the evaluation request for the work, the analysis work support module 110 advances to Step S109.

In a case of determining that the received request is the evaluation request for the work, the analysis work support module 110 receives from the analyst an evaluation obtained for the result of the analysis work (Step S107).

The analyst uses a UI to input the identification information on an analysis work to be evaluated and the information on an evaluation. At this time, the analysis work support module 110 refers to the work management information 142 to search for an entry corresponding to the analysis work to be evaluated. The analysis work support module 110 sets, in the evaluation 405 of the retrieved entry, information relating to the evaluation input by the analyst.

Subsequently, the analysis work support module 110 calls the evaluation module 133 (Step S108). After processing performed by the evaluation module 133 is brought to an end, the analysis work support module 110 advances to Step S109.

In Step S109, the analysis work support module 110 determines whether or not an end request for the operation of a system has been received (Step S109).

In a case of determining that the end request for the operation of the system has not been received, the analysis work support module 110 stands by for the input of a request to be performed by the analyst. The request to be input is a request other than the end request for the operation of the system. In a case where a request has been received from the analyst, the analysis work support module 110 returns to Step S102, and executes the same processing.

In a case of determining that the end request for the operation of the system has been received, the analysis work support module 110 executes logout processing (Step S110), and then brings the processing to an end. The logout processing is a known technology, and hence its detailed description is omitted. At this time, the pieces of data stored in the work area 112 in the series of processing steps are erased.

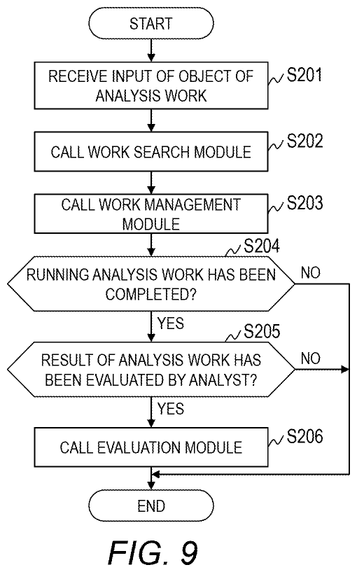

FIG. 9 is a flow chart for illustrating an example of processing to be executed by the main processing module 121 in the first embodiment. In a case where the main processing module 121 is called by the analysis work support module 110, the main processing module 121 starts processing described below.

First, the main processing module 121 receives the input of the object of a new analysis work from the analyst (Step S201). At this time, the main processing module 121 executes the following processing.

(Step S201-1) The main processing module 121 refers to the object management information 141 to search for an entry in which the value of the object summary 302 matches the input object of the new analysis work. The main processing module 121 determines whether or not the input object of the new analysis work matches the object of the analysis work stored in the object summary 302 based on, for example, similarity in character string and similarity in meaning.

(Step S201-2) In a case where there is an entry that satisfies the above-mentioned condition, the main processing module 121 obtains the value of the object ID 301 of the relevant entry, and stores the value in the work area 112.

(Step S201-3) In a case where there is no entry that satisfies the above-mentioned condition, the main processing module 121 adds the entry to the object management information 141, sets identification information in the object ID 301 of the added entry, and sets the input object of the new analysis work in the object summary 302. In addition, the main processing module 121 stores, in the work area 112, the value of the object ID 301 of the added entry. The processing executed in Step S201 has been described above.

Subsequently, the main processing module 121 calls the work search module 132 (Step S202). When the work search module 132 executes processing described later, a log (combination of tasks) is presented to the analyst as recommendation information for supporting the determination of the combination of tasks for the new analysis work. In the following description, the analysis work corresponding to the log displayed as the recommendation information is referred to as “reference work”.

After processing performed by the work search module 132 is brought to an end, the main processing module 121 calls the work management module 130 (Step S203). The analysis work is executed by the work management module 130 executing processing described later.

After processing performed by the work management module 130 is brought to an end, the main processing module 121 determines whether or not the new analysis work has been completed (Step S204).

Specifically, the main processing module 121 refers to the entry corresponding to the new analysis work in the work management information 142 to determine whether or not the status 404 is “Complete”. In a case where the status 404 is “Complete”, the main processing module 121 determines that the new analysis work has been completed.

In a case of determining that the new analysis work has not been completed, the main processing module 121 brings the processing to an end. At this time, the main processing module 121 notifies the analysis work support module 110 of the end of the processing.

In a case of determining that the new analysis work has been completed, the main processing module 121 determines whether or not the result of the new analysis work has been evaluated by the analyst (Step S205).

Specifically, the main processing module 121 refers to the entry corresponding to the new analysis work in the work management information 142 to determine whether or not a value is stored in the evaluation 405. In a case where a value is stored in the evaluation 405, the main processing module 121 determines that the result of the new analysis work has been evaluated by the analyst.

In a case of determining that the result of the new analysis work has not been evaluated by the analyst, the main processing module 121 brings the processing to an end. At this time, the main processing module 121 notifies the analysis work support module 110 of the end of the processing.

In a case of determining that the result of the new analysis work has been evaluated by the analyst, the main processing module 121 calls the evaluation module 133 (Step S206). After the processing performed by the evaluation module 133 is brought to an end, the main processing module 121 brings the processing to an end. At this time, the main processing module 121 notifies the analysis work support module 110 of the end of the processing.

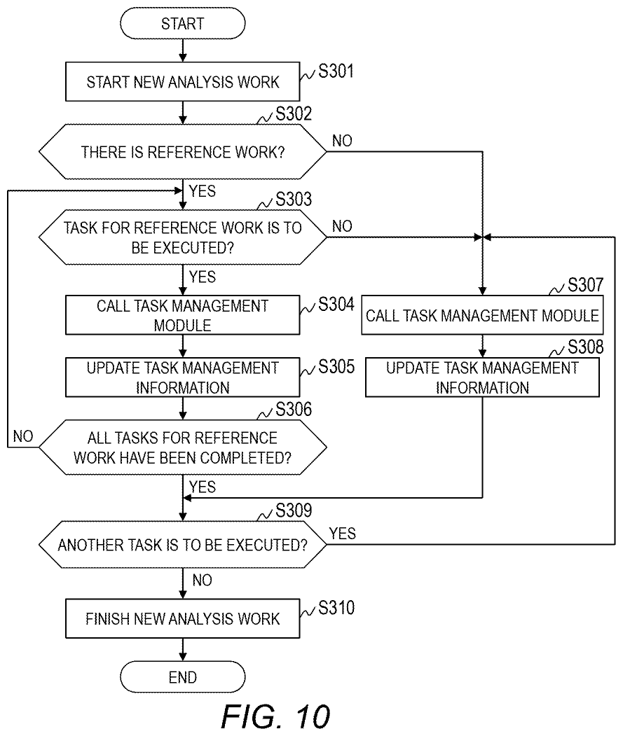

FIG. 10 is a flow chart for illustrating an example of processing to be executed by the work management module 130 in the first embodiment.

The work management module 130 starts a new analysis work (Step S301).

At this time, the work management module 130 updates the work management information 142. Specifically, the work management module 130 adds an entry to the work management information 142, and sets identification information in the work ID 401 of the added entry. The work management module 130 sets the identification information on the object and the identification information on the analyst, which are stored in the work area 112, in the object ID 402 and the analyst ID 403 of the added entry, respectively. The work management module 130 may set, for example, “Running” in the status 404 of the added entry.

Subsequently, the work management module 130 determines whether or not there is a reference work (Step S302).

Specifically, the work management module 130 determines whether or not identification information on an analysis work different from the identification information on the new analysis work is stored in the work area 112. In a case where identification information on an analysis work different from the identification information on the new analysis work is stored in the work area 112, the work management module 130 determines that there is a reference work.

In a case of determining that there is no reference work, the work management module 130 advances to Step S307.

In a case of determining that there is a reference work, the work management module 130 determines whether or not to execute a task included in the combination of tasks for the reference work (Step S303). In other words, the work management module 130 determines whether or not to divert a task for the reference work. This determination is performed based on the input received from the analyst through the UI. In the following description, the task included in the combination of tasks for the reference work is referred to as “reference task”.

In a case of determining that a task included in the combination of tasks for the reference work is not to be executed, the work management module 130 advances to Step S307.

In a case of determining that a task included in the combination of tasks for the reference work is to be executed, the work management module 130 calls the task management module 131 (Step S304). At this time, the work management module 130 inputs information on the task to be executed to the task management module 131. The information on the task can be obtained from the task detail management information 144, the operation log management information 145, and other such information. After processing performed by the task management module 131 is brought to an end, the work management module 130 advances to Step S305.

Subsequently, the work management module 130 updates the task management information 143 (Step S305).

Specifically, the work management module 130 adds an entry to the task management information 143, and sets identification information on the new analysis work and identification information on the task executed by the task management module 131 in the work ID 501 and the task ID 502 of the added entry, respectively. In addition, the work management module 130 sets a value obtained by adding 1 to the procedural step of the previous task in the procedural step 503 of the added entry.

Subsequently, the work management module 130 determines whether or not all the tasks for the reference work have been completed (Step S306).

In a case of determining that not all the tasks for the reference work have been completed, the work management module 130 returns to Step S303, and executes the same processing.

In a case of determining that all the tasks for the reference work have been completed, the work management module 130 advances to Step S309.

In Step S307, the work management module 130 calls the task management module 131 (Step S307). In this case, the task management module 131 executes the task originally set by the analyst. After the processing performed by the task management module 131 is brought to an end, the work management module 130 advances to Step S308.

Subsequently, the work management module 130 updates the task management information 143 (Step S308), and then advances to Step S309. The processing of Step S308 is the same as the processing of Step S305.

In Step S309, the work management module 130 determines whether or not to execute another task (Step S309). This determination is performed based on the input received from the analyst through the UI.

In a case of determining that another task is to be executed, the work management module 130 returns to Step S307, and executes the same processing.

In a case of determining that another task is not to be executed, the work management module 130 finishes the new analysis work (Step S310), and then brings the processing to an end.

At this time, the work management module 130 notifies the main processing module 121 of the end of the processing, and updates the work management information 142. Specifically, the work management module 130 refers to the work management information 142 to set “Complete” in the status 404 of the entry corresponding to the new analysis work. The work management module 130 also sets the current date and time in the completion date and time 406 of the entry corresponding to the new analysis work.

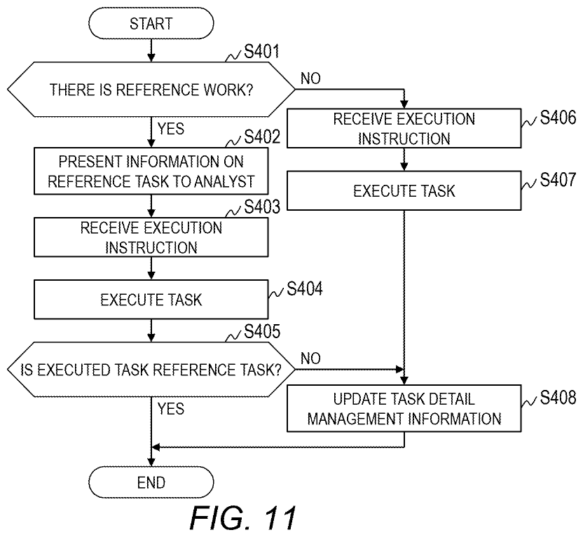

FIG. 11 is a flow chart for illustrating an example of processing to be executed by the task management module 131 in the first embodiment.

The task management module 131 determines whether or not there is a reference work (Step S401).

Specifically, the task management module 131 determines whether or not information relating to a task has been input from the work management module 130.

In a case of determining that there is a reference task, the task management module 131 presents information relating to the reference task to the analyst (Step S402).

Subsequently, the task management module 131 receives an execution instruction for a task from the analyst (Step S403), and executes the task based on the execution instruction (Step S404).

Specifically, the task management module 131 obtains information relating to tasks constructed by the work search module 132 from the work area 112, and executes a task whose execution has been instructed. At this time, the task management module 131 temporarily stores, in the work area 112, information relating to an operation including a command executed in the task. In addition to the command, logs of, for example, an operation at the time of executing the execution file 146 and an operation at the time of using a service, are also temporarily stored in the work area 112.

In regard to a service and an application provided by an external system, the computer 100 obtains operation logs of the service and the application. When logs are displayed to the analyst, only the operation logs of the service and the application that can be used by the analyst may be presented.

Subsequently, the task management module 131 determines whether or not the executed task is a reference task (Step S405). In other words, the task management module 131 determines whether or not the reference task presented in Step S402 matches the executed task.

In a case of determining that the executed task is a reference task, the task management module 131 brings the processing to an end. At this time, the task management module 131 notifies the work management module 130 of the end of the processing.

In a case of determining that the executed task is not a reference task, the task management module 131 advances to Step S408.

In a case of determining in Step S401 that there is no reference task, the task management module 131 receives an execution instruction for a task from the analyst (Step S406), and executes the task based on the execution instruction (Step S407). After that, the task management module 131 advances to Step S408. At this time, the task management module 131 temporarily stores, in the work area 112, information relating to an operation including a command executed in the task.

In Step S408, the task management module 131 updates the task detail management information 144 (Step S408). After that, the task management module 131 brings the processing to an end. At this time, the task management module 131 notifies the work management module 130 of the end of the processing. In Step S408, the following processing is executed.

(Step S408-1) The task management module 131 generates the operation log management information 145 based on the information relating to the operation. At this time, the task management module 131 sets identification information including the file name in the operation log management information 145.

(Step S408-2) The task management module 131 adds an entry to the task detail management information 144, sets identification information in the task ID 601 of the added entry, and sets the identification information on the operation log management information 145 in the operation log management information 604. In addition, the task management module 131 sets values in the input file management directory 602, the output file management directory 603, the operation program 605, and the operational service 606 of the added entry based on the content of the task. In the operation program 605 and the operational service 606, no value is set depending on the content of the task. The processing of Step S408 has been described above.

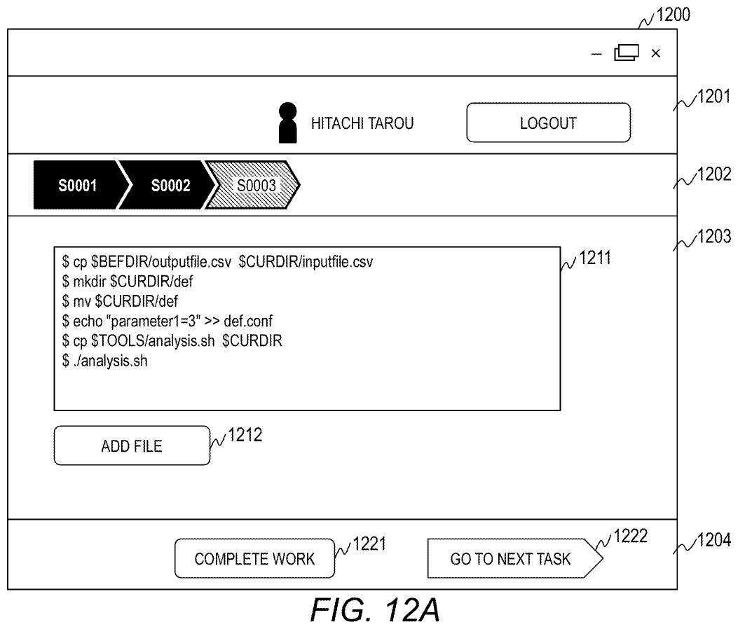

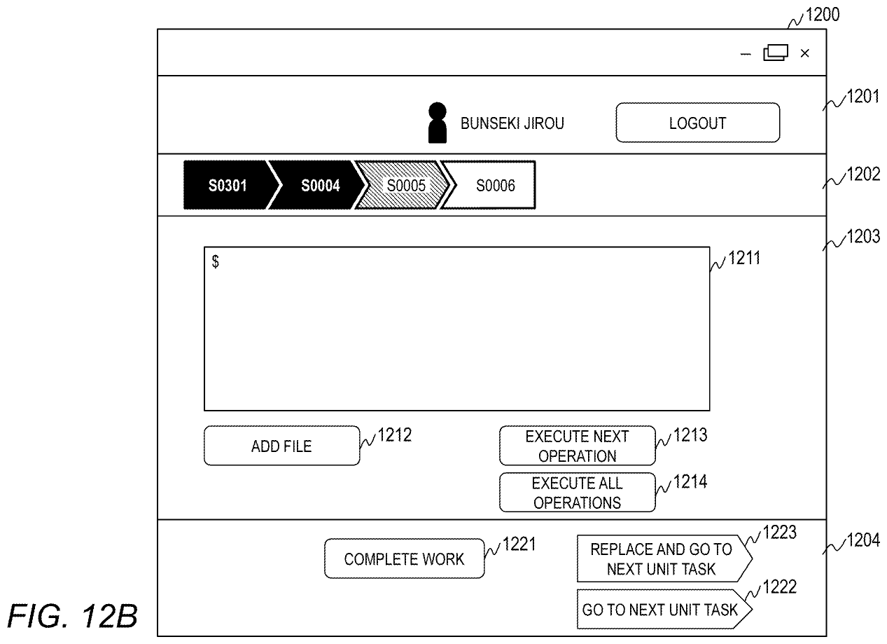

Now, flows of the processing to be performed by the work management module 130 and the processing to be performed by the task management module 131 are described with reference to the UI. FIG. 12A and FIG. 12B are diagrams for illustrating examples of the UI to be displayed by the main processing module 121 in the first embodiment.

FIG. 12A is an illustration of an example of a UI 1200 to be displayed when there is no reference work or when a task other than a task for a reference work is performed. The UI 1200 includes a user field 1201, an analysis work field 1202, a task execution field 1203, and an operation button field 1204. In the user field 1201, the name of the analyst and a login button or a logout button are displayed. In FIG. 12A, the user has already logged in, and hence a logout button is displayed in the user field 1201.

The analysis work field 1202 is a field for displaying a combination of tasks for the currently running analysis work. In the analysis work field 1202, symbols representing the tasks are displayed in the execution order of the tasks. The filled-in black symbol represents the executed task, and the hatched symbol represents the task to be executed.

The task execution field 1203 is a field for the analyst to set or confirm a specific operation of the task and output an execution instruction. The task execution field 1203 includes a command input field 1211 and a file addition button 1212.

The command input field 1211 is a field for inputting a command for achieving an operation to be performed in the task. The command set in the command input field 1211 is recorded in the operation log management information 145. The file addition button 1212 is an operation button for loading a file. In a case where the analyst operates the file addition button 1212, a file storing the command set in the command input field 1211 is uploaded onto the computer 100. The task detail management information 144, the operation log management information 145, and other such information are updated based on the file.

The operation button field 1204 is a field for displaying operation buttons for instructing, for example, continuation and termination of the analysis work. The operation button field 1204 includes a work completion button 1221 and a task addition button 1222.

The work completion button 1221 is an operation button for instructing completion of the analysis work. In a case where the analyst operates the work completion button 1221, the work management module 130 determines in Step S309 that another task is not to be executed.

The task addition button 1222 is an operation button for instructing execution of a new task. In a case where the analyst operates the task addition button 1222, the work management module 130 determines in Step S309 that another task is to be executed.

FIG. 12B is an illustration of an example of the UI 1200 to be displayed when there is a reference work. The UI 1200 includes the user field 1201, the analysis work field 1202, the task execution field 1203, and the operation button field 1204.

In the analysis work field 1202, a combination of tasks for the reference work is displayed. The filled-in white symbol represents a task scheduled to be executed.

The task execution field 1203 includes not only the command input field 1211 and the file addition button 1212 but also an individual operation execution button 1213 and a collective operation execution button 1214.

In the command input field 1211, a command executed in the reference task is displayed. The analyst is allowed to add, delete, and modify the command displayed in the command input field 1211 as the requirement arises. In the following description, the addition, deletion, and modification of a command are referred to as the update of a command.

The individual operation execution button 1213 is an operation button for displaying the command executed in the reference task in the command input field 1211. In a case where the displayed command is to be executed as it is, the analyst inputs an execution instruction for the command. In a case where the displayed command is not to be executed as it is, the analyst updates the command, and inputs the execution instruction for the updated command. In a case where the updated command has been executed, the task management module 131 determines in Step S405 that the executed task is not a reference task.

The collective operation execution button 1214 is an operation button for instructing execution of all commands after the executed command. In a case where the collective operation execution button 1214 is operated under a state in which no command is executed, the command in the reference task is executed as it is.

It should be noted that a task initialization button may be provided in the task execution field 1203. In a case where the task initialization button is operated, the task is restarted from the beginning.

The operation button field 1204 includes not only the work completion button 1221 and the task addition button 1222 but also a replacement task addition button 1223.

While the command of the reference task is being executed without being updated, the task addition button 1222 is enabled, and the replacement task addition button 1223 is disabled. Meanwhile, after the command of the reference task is updated, the replacement task addition button 1223 is enabled, and the task addition button 1222 is disabled.

In a case where the task addition button 1222 is operated, the work management module 130 determines in Step S303 that a task included in the combination of tasks for the reference work is to be executed. In a case where the replacement task addition button 1223 is operated, the work management module 130 determines in Step S303 that a task included in the combination of tasks for the reference work is not to be executed. In a case where the replacement task addition button 1223 is operated, the UI 1200 illustrated in FIG. 12B is switched over to the UI 1200 illustrated in FIG. 12A.

The flows of the processing to be performed by the work management module 130 and the processing to be performed by the task management module 131 have been described above.

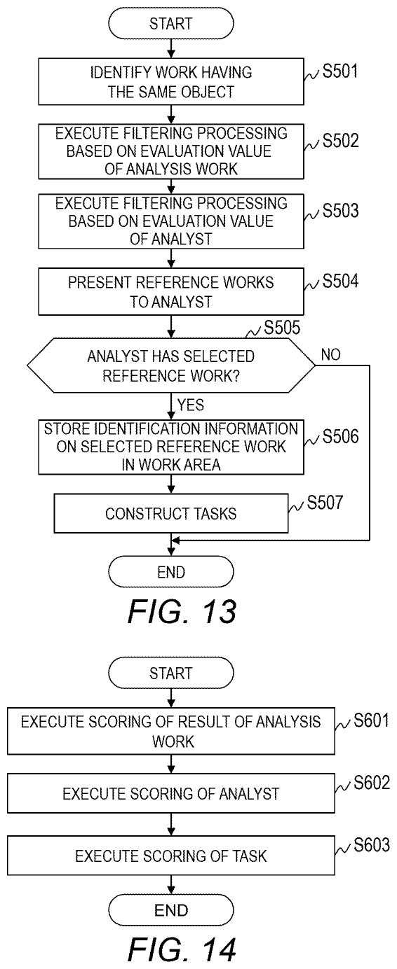

FIG. 13 is a flow chart for illustrating an example of processing to be executed by the work search module 132 in the first embodiment.

The work search module 132 refers to the work management information 142 to identify a work having the same object as that of the new analysis work (Step S501).

Specifically, the work search module 132 searches for an entry in which the value of the object ID 402 matches the identification information on the object stored in the work area 112. The work search module 132 generates a work list formed of the value of the work ID 401 and the value of the analyst ID 403 of the retrieved entry, and stores the work list in the work area 112.

Subsequently, the work search module 132 executes filtering processing based on the evaluation value of the analysis work (Step S502). Through this processing, a highly evaluated analysis work is selected. Specifically, the following processing is executed.

(Step S502-1) The work search module 132 selects a target analysis work from among the analysis works registered in the work list.

(Step S502-2) The work search module 132 refers to the task management information 143 to search for entries in each of which the value of the work ID 501 matches the identification information on the target analysis work. Through the search, the combination of tasks for the target analysis work is identified. The work search module 132 refers to the task detail management information 144 to search for entries in each of which the value of the task ID 601 matches the value of the task ID 502 of the retrieved entry.

(Step S502-3) The work search module 132 obtains the values of the first scores 607 of the retrieved entries from the task detail management information 144. In other words, the work search module 132 obtains the scores of all the tasks included in the target analysis work. The work search module 132 calculates the total value of the obtained scores as the evaluation value of the target analysis work. The method of calculating the evaluation value of the analysis work is merely an example, and this invention is not limited thereto. Any calculation method may be employed as long as the score of the work is used.

(Step S502-4) The work search module 132 determines whether or not the evaluation value has been calculated for all the analysis works registered in the work list. In a case where the evaluation value has not been calculated for all the analysis works registered in the work list, the work search module 132 returns to (Step S502-1), and executes the same processing.

(Step S502-5) In a case where the evaluation value has been calculated for all the analysis works registered in the work list, the work search module 132 compares the evaluation value of the analysis work with a threshold value, and updates the work list based on the comparison result. For example, the work search module 132 deletes, from the work list, the analysis work whose evaluation value is smaller than the threshold value. The threshold value can be set freely. The processing of Step S502 has been described above.

Subsequently, the work search module 132 executes filtering processing based on the evaluation value of the analyst who has executed an analysis work (Step S503). Through this processing, the analysis work executed by a highly evaluated analyst is selected. Specifically, the following processing is executed.

(Step S503-1) The work search module 132 selects a target analysis work from among the analysis works registered in the work list.

(Step S503-2) The work search module 132 refers to the analyst management information 140 to search for an entry in which the analyst ID 201 matches the identification information on the analyst (value of the analyst 403) who has executed the target analysis work. The work search module 132 obtains the analyst score 203 of the retrieved entry as the evaluation value of the analyst.

(Step S503-3) The work search module 132 determines whether or not the evaluation value of the analyst who has executed the analysis work has been obtained for all the analysis works registered in the work list. In a case where the evaluation value of the analyst who has executed the analysis work has not been obtained for all the analysis works registered in the work list, the work search module 132 returns to (Step S503-1), and executes the same processing.

(Step S503-4) In a case where the evaluation value of the analyst who has executed the analysis work has been obtained for all the analysis works registered in the work list, the work search module 132 compares the evaluation value of the analysis work with a threshold value, and updates the work list based on the comparison result. For example, the work search module 132 deletes, from the work list, the analysis work whose evaluation value of the analyst is smaller than the threshold value. The threshold value can be set freely. The processing of Step S503 has been described above.

Each analysis work registered in the work list obtained after the filtering processing has been executed for all the analysis works is used as a reference work.

Subsequently, the work search module 132 presents the logs of reference works registered in the work list to the analyst (Step S504).

At this time, the work search module 132 may sort the analysis works in the work list based on the evaluation value of the analysis work and the evaluation value of the analyst. For example, the work search module 132 sorts the analysis works in descending order of the evaluation value of the analysis work. The work search module 132 also sorts the analysis works having the same evaluation value in descending order of the evaluation value of the analyst.

The work search module 132 may also select a predetermined number of analysis works based on the evaluation value of the analysis work and the evaluation value of the analyst to present the logs of the selected analysis works.

Subsequently, the work search module 132 determines whether or not the analyst has selected the reference work (Step S505).

In a case of determining that the analyst has not selected the reference work, the work search module 132 brings the processing to an end. At this time, the work search module 132 deletes the work list from the work area 112, and notifies the main processing module 121 of the end of the processing.

In a case of determining that the analyst has selected the reference work, the work search module 132 stores the identification information on the selected reference work in the work area 112 (Step S506).

Subsequently, the work search module 132 constructs tasks for a new analysis work based on the combination of tasks for the reference work (Step S507). After that, the work search module 132 brings the processing to an end. At this time, the work search module 132 deletes the work list from the work area 112, and notifies the main processing module 121 of the end of the processing.

Specifically, the work search module 132 obtains information relating to the combination of tasks for the reference work from the task management information 143, the task detail management information 144, and the operation log management information 145 based on the identification information on the reference work. The work search module 132 determines storage locations of an input file and an output file based on the identification information on the new analysis work and the identification information on the analyst. The work search module 132 stores, in the work area 112, the information relating to the combination of tasks for the reference work and information on the storage locations of the input file and the output file.

The processing of Step S503 may be omitted.

FIG. 14 is a flow chart for illustrating an example of processing to be executed by the evaluation module 133 in the first embodiment.

The evaluation module 133 executes the scoring of the result of the analysis work based on the evaluation obtained for the result of the analysis work (Step S601).

The evaluation module 133 calculates the score of the result of the analysis work to be evaluated based on the evaluation obtained for the result of the analysis work to be evaluated and the evaluation obtained for the result of the analysis work diverting a part of the combination of tasks for the relevant analysis work. Specifically, the following processing is executed.

(Step S601-1) The evaluation module 133 refers to the work management information 142 to search for an entry in which the value of the work ID 401 matches the identification information on the analysis work to be evaluated. The evaluation module 133 obtains the value of the evaluation 405 of the retrieved entry, and calculates a score from the obtained value. The evaluation module 133 stores the calculated score in the work area 112. At this time, the evaluation module 133 stores the value of the analyst ID 403 of the retrieved entry in the work area 112.

For example, in a case where the value of the evaluation 405 is a numerical value, the evaluation module 133 calculates the score from the numerical value. In a case where the value of the evaluation 405 is a character string or a symbol, the evaluation module 133 calculates the score from the character string or the symbol in accordance with a conversion rule. The conversion rule is set in advance.

(Step S601-2) The evaluation module 133 refers to the task management information 143 to search for an entry in which the value of the work ID 501 matches the identification information on the analysis work to be evaluated.

The evaluation module 133 then stores the value of the task ID 502 of the retrieved entry in the work area 112. In addition, the evaluation module 133 identifies the final task for the analysis work to be evaluated based on the procedural step 503 of the retrieved entry.

(Step S601-3) The evaluation module 133 refers to the task detail management information 144 to search for an entry in which the value of the task ID 601 matches the identification information on the identified final task. The evaluation module 133 adds the score stored in the work area 112 to the value of the second score 608 of the retrieved entry.

In this case, the above-mentioned processing is assumed to be executed each time the analysis work is evaluated. However, the processing may be executed after the evaluation of the analysis work has been accumulated for a fixed period. In this case, the evaluation module 133 identifies analysis works having the same object and the same final task. In other words, a standard analysis work and analysis works diverting the standard analysis work are identified. The evaluation module 133 adds the total value of the scores of the identified analysis works to the second score 608. The processing of Step S601 has been described above.

Subsequently, the evaluation module 133 executes the scoring of the analyst based on the evaluation obtained for the result of the analysis work (Step S602).

The evaluation module 133 calculates the score of the analyst based on the diversion result of the task in the analysis work. Specifically, the following processing is executed.

(Step S602-1) The evaluation module 133 refers to the task management information 143 to identify analysis works in each of which the final task is the same as the final task for the analysis work to be evaluated. The evaluation module 133 refers to the work management information 142 to search for entries in each of which the value of the work ID 401 matches the identification information on the identified analysis work. At this time, the analysis work to be evaluated is excluded from search targets.

(Step S602-2) The evaluation module 133 selects a target task from the combination of tasks for the analysis work to be evaluated.

(Step S602-3) The evaluation module 133 identifies analysis works including the target task from among the analysis works corresponding to the retrieved entries. The evaluation module 133 then identifies analysis works each having the completion date and time 406 earlier than the completion date and time 406 of the analysis work to be evaluated from among the retrieved analysis works. In other words, the analysis works executed before the execution of the analysis work to be evaluated are identified. The evaluation module 133 further identifies an analysis work having the earliest completion date and time 406 from among the identified analysis works. The evaluation module 133 stores the identification information on the identified analysis work in the work area 112. In a case where the identification information on the same analysis work has already been stored in the work area 112, the evaluation module 133 does not store the identification information on the analysis work.

In this case, Step S602-3 is processing for identifying the analysis work in which the task diverted by the analysis work to be evaluated was first executed.

(Step S602-4) The evaluation module 133 determines whether or not the processing has been completed for all the tasks for the analysis work to be evaluated. In a case where the processing has not been completed for all the tasks for the analysis work to be evaluated, the evaluation module 133 returns to Step S602-2, and executes the same processing.

(Step S602-5) In a case where the processing has been completed for all the tasks for the analysis work to be evaluated, the evaluation module 133 obtains one piece of identification information on the analysis works stored in the work area 112. The evaluation module 133 refers to the work management information 142 to search for an entry in which the value of the work ID 401 matches the obtained identification information on the analysis work. The evaluation module 133 determines whether or not the value of the analyst ID 403 of the retrieved entry matches the identification information on the analyst of the analysis work to be evaluated. In other words, the evaluation module 133 determines whether or not the analysts of the two analysis works are the same.

(Step S602-6) In a case of determining that the analysts of the two analysis works are the same, the evaluation module 133 determines whether or not the processing has been completed for all the identified analysis works. In a case of determining that the analysts of the two analysis works are different from each other, the evaluation module 133 refers to the analyst management information 140 to search for an entry in which the value of the analyst ID 201 matches the value of the analyst ID 403 of the retrieved entry. The evaluation module 133 adds the score stored in the work area 112 to the value of the analyst score 203 of the retrieved entry. After that, the evaluation module 133 determines whether or not the processing has been completed for all the identified analysis works.

The evaluation module 133 may calculate a value to be added based on the score and a coefficient determined from the degree of matching between the task included in the analysis work to be evaluated and the task included in the retrieved analysis work.

(Step S602-7) In a case where the processing has not been completed for all the identified analysis works, the evaluation module 133 returns to Step S602-5, and executes the same processing. In a case where the processing has been completed for all the identified analysis works, the evaluation module 133 brings the processing of Step S602 to an end.

In this case, the above-mentioned processing is assumed to be executed each time the analysis work is evaluated. However, the processing may be executed after the evaluation of the analysis work has been accumulated for a fixed period. In this case, the evaluation module 133 identifies analysis works having the same object and the same final task. In other words, a standard analysis work and analysis works diverting the standard analysis work are identified. The evaluation module 133 adds the total value of the scores of the identified analysis works to the analyst score 203 of the entry corresponding to the analyst who has executed the standard analysis work.

The scoring of the analyst in consideration of the diversion result of the analysis work enables the objective evaluation of the experience and ability of the analyst. The processing of Step S602 has been described above.

Subsequently, the evaluation module 133 executes the scoring of a task included in an analysis work based on the evaluation obtained for the result of the analysis work (Step S603). After that, the evaluation module 133 brings the processing to an end. At this time, the evaluation module 133 notifies the analysis work support module 110 or the main processing module 121, which has called the evaluation module 133, of the end of the processing.

The evaluation module 133 calculates the score of the task included in the analysis work to be evaluated based on the evaluation obtained for the result of the analysis work to be evaluated and the evaluation obtained for the result of the analysis work diverting a part of the combination of tasks for the relevant analysis work. Specifically, the following processing is executed.

(Step S603-1) The evaluation module 133 refers to the task management information 143 to search for entries in each of which the value of the work ID 501 matches the identification information on the analysis work to be evaluated.

(Step S603-2) The evaluation module 133 selects a target task from among the works corresponding to the retrieved entries.

(Step S603-3) The evaluation module 133 refers to the task detail management information 144 to search for an entry in which the value of the task ID 601 matches the identification information on the target task. The evaluation module 133 adds the score stored in the work area 112 to the value of the first score 607 of the retrieved entry.

(Step S603-4) The evaluation module 133 determines whether or not the processing has been executed for all the tasks included in the analysis work to be evaluated.

(Step S603-5) In a case of determining that the processing has not been executed for all the tasks included in the analysis work to be evaluated, the evaluation module 133 returns to Step S603-2, and executes the same processing. In a case of determining that the processing has been executed for all the tasks included in the analysis work to be evaluated, the evaluation module 133 brings the processing of Step S603 to an end.

In this case, the above-mentioned processing is assumed to be executed each time the analysis work is evaluated. However, the processing may be executed after the evaluation of the analysis work has been accumulated for a fixed period. In this case, the evaluation module 133 identifies analysis works having the same object and the same final task. In other words, a standard analysis work and analysis works diverting the standard analysis work are identified. The evaluation module 133 adds the total value of the scores of the standard analysis work and the identified analysis works to the first score 607 of the entry corresponding to the task included in each analysis work.

The scoring of the task in consideration of the diversion result of the analysis work enables the efficient and accurate evaluation of the usefulness of the analysis work. The processing of Step S603 has been described above.

The processing of Step S602 and the processing of Step S603 may be switched over.

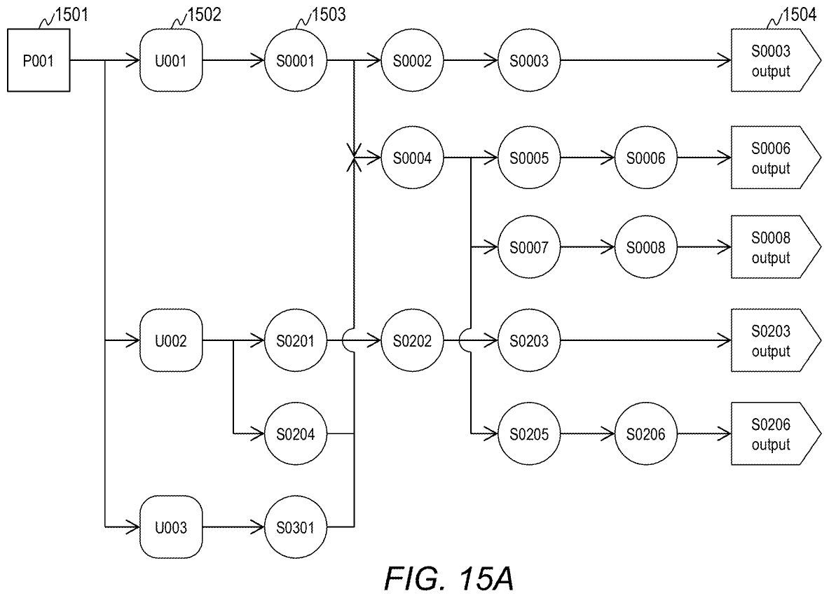

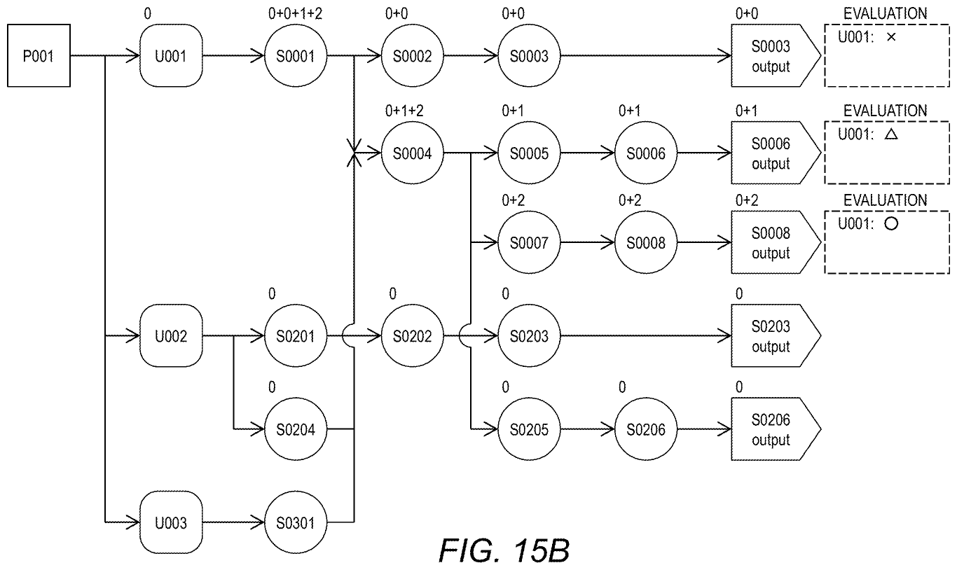

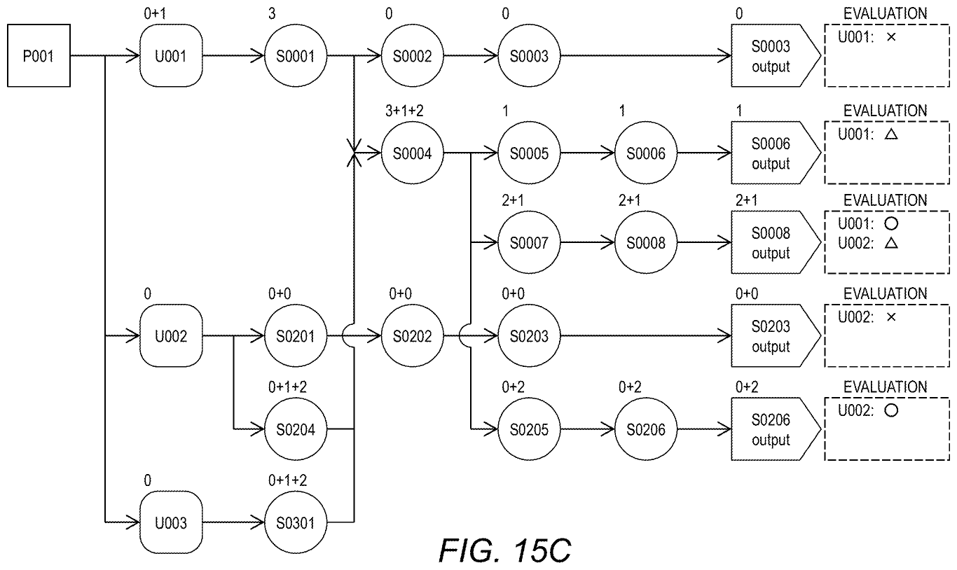

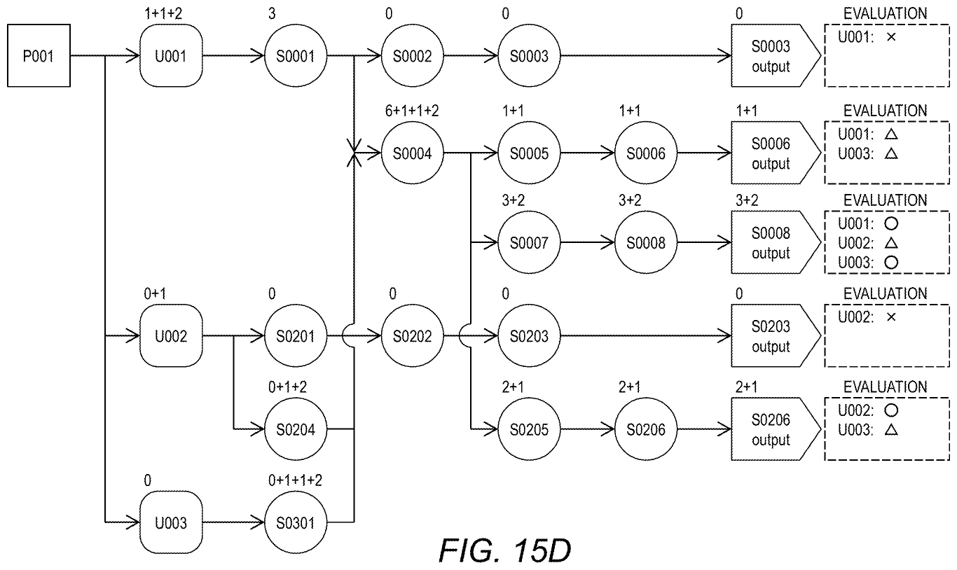

Now, a description is given of the concept of the processing to be executed by the evaluation module 133. FIG. 15A, FIG. 15B, FIG. 15C, and FIG. 15D are diagrams for describing the concept of the processing executed by the evaluation module 133 in the first embodiment.

In this case, it is assumed that the analyst “U001” executed an analysis work A101, an analysis work A102, and an analysis work A103, the analyst “U002” then executed an analysis work A201, an analysis work A202, and an analysis work A203, and the analyst “U003” then executed an analysis work A301, an analysis work A302, and an analysis work A303.

The combination of tasks for the analysis work A101 is Step S0001, Step S0002, and Step S0003, the combination of tasks for the analysis work A102 is Step S0001, Step S0004, Step S0005, and Step S0006, and the combination of tasks for the analysis work A103 is Step S0001, Step S0004, Step S0007, and Step S0008.

The combination of tasks for the analysis work A201 is Step S0201, Step S0202, and Step S0203, the combination of tasks for the analysis work A202 is Step S0204, Step S0004, Step S0007, and Step S0008, and the combination of tasks for the analysis work A203 is Step S0204, Step S0004, Step S0205, and Step S0206.

The analysis work A202 and the analysis work A203 divert a part of the tasks included in the combination of tasks for the analysis work executed by the analyst “U001”.

The combination of tasks for the analysis work A301 is Step S0301, Step S0004, Step S0205, and Step S0206, the combination of tasks for the analysis work A302 is Step S0301, Step S0004, Step S0005, and Step S0006, and the combination of tasks for the analysis work A303 is Step S0301, Step S0004, Step S0007, and Step S0008.

The analysis work A301 diverts a part of the tasks included in the combinations of tasks for the analysis works executed by the analyst “U001” and the analyst “U002”. The analysis work A302 and the analysis work A303 divert a part of the tasks included in the combination of tasks for the analysis work executed by the analyst “U001”.

The evaluation of the analyst is assumed to be any one of “round”, “triangle”, and “cross”. It is also assumed that a conversion rule for converting “cross” into the score of “0”, “triangle” into the score of “1”, and “round” into the score of “2” is set in the evaluation module 133.

In this case, a directed graph for showing relationships among the object of an analysis work, the analyst, the combination of tasks for the analysis work, and the result of the analysis work is constructed. Specifically, a node representing the object of an analysis work is coupled to a node representing the analyst, a node representing the analyst is coupled to a node group representing the combination of tasks for the analysis work, and a node representing the result of a node corresponding to the final task for the analysis work is coupled. Through the above-mentioned coupling, such a directed graph as shown in FIG. 15A can be constructed. A node 1501 is a node representing the object of an analysis work, a node 1502 is a node representing a user, a node 1503 is a node representing a task, and a node 1504 is a node representing the result of the analysis work. The combination of tasks for the analysis work is represented by a directed graph constructed of the nodes 1503 representing the tasks. An initial score of “0” is set for each of the nodes 1502, 1503, and 1504. The score set for the node 1502 corresponds to the evaluation value (analyst score 203) of the analyst, the score set for the node 1503 corresponds to the evaluation value (first score 607) of the work, and the score set for the node 1504 corresponds to the evaluation value (second score 608) of the result of the analysis work.

In the following description, the node 1501 is referred to as “root node”, the node 1502 is referred to as “user node”, the node 1503 is referred to as “work node”, and the node 1504 is referred to as “result node”.

In FIG. 15B, there is shown a state of the evaluation values obtained when the analyst “U001” sets the evaluation “cross” for the result of the analysis work A101, sets the evaluation “triangle” for the result of the analysis work A102, and sets the evaluation “round” for the result of the analysis work A103.

The evaluation module 133 adds “0” to the result node “Step S0003” based on the evaluation obtained for the result of the analysis work A101 (Step S601), and further adds “0” to the work nodes “Step S0001”, “Step S0002”, and “Step S0003” (Step S603). The evaluation module 133 adds “1” to the result node “Step S0006” based on the evaluation obtained for the result of the analysis work A102 (Step S601), and further adds “1” to the work nodes “Step S0001”, “Step S0004”, “Step S0005”, and “Step S0006” (Step S603). The evaluation module 133 adds “2” to the result node “Step S0008” based on the evaluation obtained for the result of the analysis work A103 (Step S601), and further adds “2” to the work nodes “Step S0001”, “Step S0004”, “Step S0007”, and “Step S0008” (Step S603).

The analysis work A101 and the analysis work A102 do not divert the task for another analyst, and hence the scoring of the analyst is not executed.

In FIG. 15C, there is shown a state of the evaluation values obtained when the analyst “U002” sets the evaluation “cross” for the result of the analysis work A201, sets the evaluation “triangle” for the result of the analysis work A202, and sets the evaluation “round” for the result of the analysis work A203.

The evaluation module 133 adds “0” to the result node “Step S2003” based on the evaluation obtained for the result of the analysis work A201 (Step S601), and further adds “0” to the work nodes “Step S0201”, “Step S0202”, and “Step S0203” (Step S603). The evaluation module 133 adds “1” to the result node “Step S0008” based on the evaluation obtained for the result of the analysis work A202 (Step S601), and further adds “1” to the work nodes “Step S0204”, “Step S0004”, “Step S0007”, and “Step S0008” (Step S603). The evaluation module 133 adds “2” to the result node “Step S0206” based on the evaluation obtained for the result of the analysis work A203 (Step S601), and further adds “2” to the work nodes “Step S0204”, “Step S0004”, “Step S0205”, and “Step S0206” (Step S603).

The analysis work A202 has the same final task as the final task for the analysis work A103, and diverts some of the tasks for the analysis work A103. Therefore, the evaluation module 133 adds “1” to the user node “U0001” based on the evaluation obtained for the result of the analysis work A202 (Step S602).

In FIG. 15D, there is shown a state of the evaluation values obtained when the analyst “U003” sets the evaluation “triangle” for the result of the analysis work A301, sets the evaluation “triangle” for the result of the analysis work A302, and sets the evaluation “round” for the result of the analysis work A303.

The evaluation module 133 adds “1” to the result node “Step S2006” based on the evaluation obtained for the result of the analysis work A301 (Step S601), and further adds “1” to the work nodes “Step S0301”, “Step S0004”, “Step S0205”, and “Step S0206” (Step S603). The evaluation module 133 adds “1” to the result node “Step S0006” based on the evaluation obtained for the result of the analysis work A302 (Step S601), and further adds “1” to the work nodes “Step S0301”, “Step S0004”, “Step S0005”, and “Step S0006” (Step S603). The evaluation module 133 adds “2” to the result node “Step S0208” based on the evaluation obtained for the result of the analysis work A303 (Step S601), and further adds “2” to the work nodes “Step S0301”, “Step S0004”, “Step S0007”, and “Step S0008” (Step S603).

The analysis work A301 has the same final task as the final task for the analysis work A203, and diverts some of the tasks for the analysis work A203. Therefore, the evaluation module 133 adds “1” to the user node “U0002” based on the evaluation obtained for the result of the analysis work A301 (Step S602). The analysis work A302 has the same final task as the final task for the analysis work A102, and diverts some of the tasks for the analysis work A102. Therefore, the evaluation module 133 adds “1” to the user node “U0001” based on the evaluation obtained for the result of the analysis work A302 (Step S602). The analysis work A303 has the same final task as the final task for the analysis work A103, and diverts some of the tasks for the analysis work A103. Therefore, the evaluation module 133 adds “2” to the user node “U0001” based on the evaluation obtained for the result of the analysis work A303 (Step S602).

In a case where the work search module 132 executes the processing under such a state of the scores as shown in FIG. 15D, the evaluation values of the analysis works A101, A102, A103, A201, A202, A203, A301, A302, and A303 are “3”, “17”, “23”, “0”, “23”, “19”, “20”, “18”, and “24”, respectively.

In a case where the threshold value is set to “20” in Step S502, the analysis works A103, A202, A301, and A303 remain in the work list. In addition, in a case where the threshold value is set to “1” in Step S503, the analysis works A103 and A202 remain in the work list. In Step S504, the evaluation module 133 presents, for example, the analysis work A103 as a reference work. The evaluation module 133 may present such a directed graph as shown in FIG. 15D.

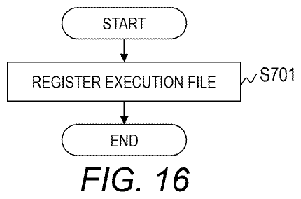

FIG. 16 is a flow chart for illustrating an example of processing to be executed by the pre-processing module 120 in the first embodiment.

The pre-processing module 120 presents an interactive mode UI, and receives a registration request for the execution file 146 through the UI. The registration request includes data being the entity of the execution file 146.

In a case of receiving the registration request for the execution file 146, the pre-processing module 120 registers the execution file 146 (Step S701), and then brings the processing to an end. At this time, the pre-processing module 120 notifies the analysis work support module 110 of the end of the processing.

According to the first embodiment, the computer 100 can present logs of analysis works serving as a reference in order to determine the combination of tasks for a new analysis work through use of the evaluation values of the analysis works and the evaluation values of the analysts, which are calculated based on the evaluations obtained for the results of the analysis works.

The analyst can execute the analysis work with reference to the presented logs of the analysis works. Therefore, even when the analyst is a novice, it is possible to execute an analysis work capable of producing a useful result at a certain level or higher. The analyst can also obtain know-how on the analysis work by referring to the presented analysis work. In addition, it is possible to reduce the cost required for the analysis work by diverting the past analysis work.

This invention is also applicable to a work other than the analysis work. For example, this invention can be applied to a manufacturing work including a plurality of manufacturing tasks.

### Second Embodiment

A second embodiment of this invention is partially different in processing to be executed by the work search module 132. Now, the second embodiment is described mainly in terms of differences from the first embodiment.

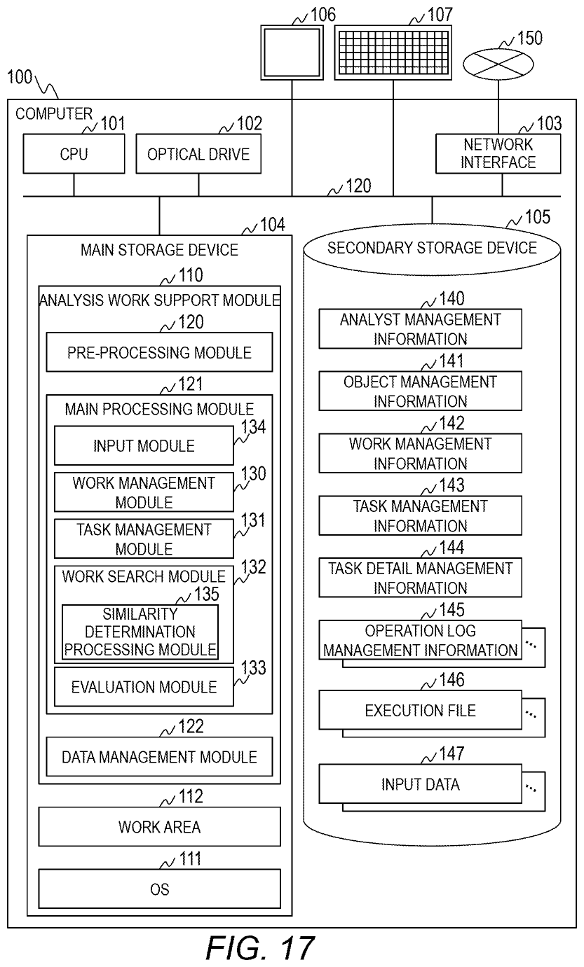

FIG. 17 is a diagram for illustrating an example of a hardware configuration and a software configuration of the computer 100 in the second embodiment.

The hardware configuration of the computer 100 in the second embodiment is the same as that in the first embodiment.

The second embodiment is different from the first embodiment in that input data 147 is stored in the secondary storage device 105. The input data 147 is data input in each task for the analysis work.

In the second embodiment, the main processing module 121 newly includes an input module 134. In addition, the work search module 132 includes a similarity determination processing module 135.

The input module 134 registers the input data 147. The similarity determination processing module 135 determines similarity between pieces of input data 147.

In the second embodiment, the task management information 143 is partially different. The other pieces of information are the same as those in the first embodiment.

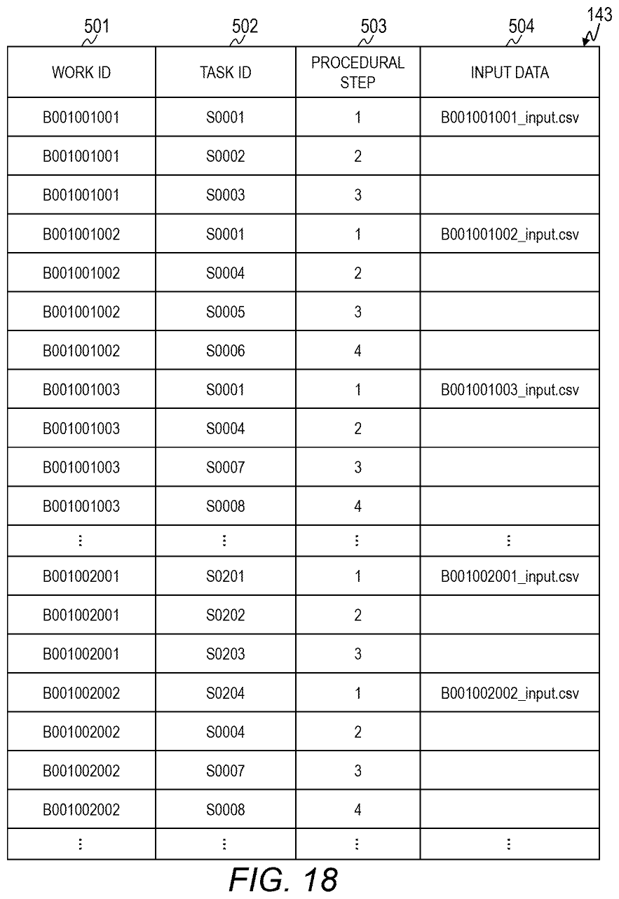

FIG. 18 is a table for showing an example of the data structure of the task management information 143 in the second embodiment.

The entry stored in the task management information 143 newly includes input data 504. The input data 504 is a field for storing identification information on the input data 147. The input data 504 stores, for example, a file name.

The computer 100 may hold information for managing the input data 147. For example, information for storing an entry in association with the analysis work, the task, and the input data 147 is conceivable. In this case, the input data 504 of the task management information 143 is not required.

The processing to be executed by the analysis work support module 110, the processing to be executed by the task management module 131, the processing to be executed by the evaluation module 133, and the processing to be executed by the pre-processing module 120 are the same as those in the first embodiment.

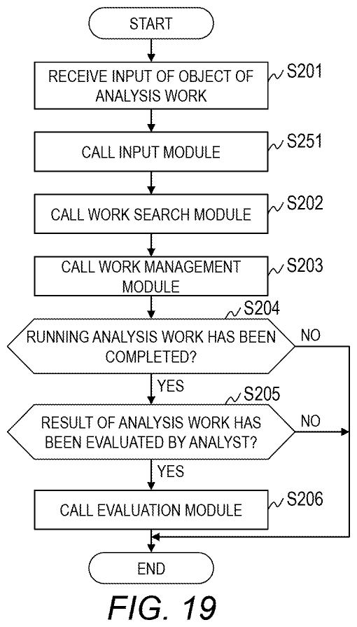

FIG. 19 is a flow chart for illustrating an example of processing to be executed by the main processing module 121 in the second embodiment.

After receiving the input of the object of the new analysis work from the analyst (Step S201), the main processing module 121 calls the input module 134 (Step S251).

The input module 134 obtains the input data 147 from the analyst, and stores the input data 147 in the secondary storage device 105. At this time, the input module 134 stores the identification information on the input data 147 in the work area 112.

The processing from Step S201 to Step S206 is the same as the processing in the first embodiment, and hence its detailed description is omitted.

The flow of the processing to be executed by the work management module 130 is the same as that in the first embodiment. However, the processing of Step S305 and Step S308 is partially different. Specifically, the work management module 130 adds an entry to the task management information 143, and sets identification information on the new analysis work and identification information on the task executed by the task management module 131 in the work ID 501 and the task ID 502 of the added entry, respectively. In addition, the work management module 130 sets a value obtained by adding 1 to the procedural step of the previous task to the procedural step 503 of the added entry. The work management module 130 further sets the identification information on the input data 147 used in the work in the input data 504 of the added entry. The identification information on the input data 147 is obtained from the work area 112.

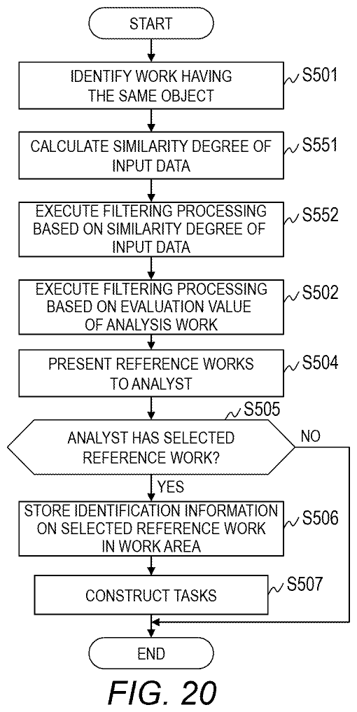

FIG. 20 is a flow chart for illustrating an example of processing to be executed by the work search module 132 in the second embodiment.

After the processing of Step S501 is executed, the work search module 132 calculates a similarity degree between input data to be handled in the new analysis work and input data that has been handled in the identified analysis work (Step S551). Specifically, the following processing is executed.

(Step S551-1) The similarity determination processing module 135 selects a target analysis work from among the analysis works registered in the work list.

(Step S551-2) The similarity determination processing module 135 refers to the task management information 143 to search for an entry in which the value of the work ID 501 matches the identification information on the target analysis work. The similarity determination processing module 135 obtains the input data 147 handled in the target analysis work based on the input data 504 of the retrieved entry.

(Step S551-3) The similarity determination processing module 135 calculates a similarity degree between input data to be handled in the new analysis work and the input data 147 handled in the target analysis work.

For example, the similarity determination processing module 135 calculates a similarity degree of the name of the input data 147. The similarity determination processing module 135 also refers to, for example, the header of the input data 147 to calculate a similarity degree of the number of columns and a similarity degree of a column name. The above-mentioned method of calculating the similarity degree is merely an example, and this invention is not limited thereto. As the similarity degree, it is conceivable to use any one of, for example, a Euclidean distance, a Pearson product-moment correlation coefficient, and a Jaccard coefficient.

(Step S551-4) The similarity determination processing module 135 determines whether or not the processing has been completed for all the analysis works registered in the work list. In a case where the processing has not been completed for all the analysis works registered in the work list, the similarity determination processing module 135 returns to Step S551-1, and executes the same processing. In a case where the processing has been completed for all the analysis works registered in the work list, the similarity determination processing module 135 brings the processing of Step S551 to an end. The processing of Step S551 has been described above.

Subsequently, the work search module 132 executes filtering processing based on the similarity degree of the input data (Step S552).

Specifically, the work search module 132 compares the similarity degree of the input data with a threshold value, and updates the work list based on the comparison result. For example, the work search module 132 deletes, from the work list, an analysis work whose similarity degree of the input data is smaller than the threshold value. The threshold value can be set freely.

The processing of Step S502 and the processing from Step S504 to Step S507 are the same as those in the first embodiment. In the processing illustrated in FIG. 20, the processing of Step S503 is omitted, but the processing of Step S503 may be executed.

According to the second embodiment, an analysis work to be presented as a reference work can be selected from analysis works that handle similar data.

### Third Embodiment

In a third embodiment of this invention, the computer 100 changes a selection method for a reference work based on the evaluation obtained for the result of the analysis work executed with the reference work being used as a reference. Now, the third embodiment is described mainly in terms of differences from the first embodiment.

A hardware configuration and a software configuration of the computer 100 in the third embodiment are the same as those in the first embodiment. The information held by the computer 100 in the third embodiment is the same as that in the first embodiment.

The processing to be executed in the third embodiment by the analysis work support module 110, the processing to be executed by the work management module 130, the processing to be executed by the evaluation module 133, and the processing to be executed by the pre-processing module 120 are the same as those in the first embodiment.

The flow of processing to be executed by the task management module 131 in the third embodiment is the same as that in the first embodiment. However, in a case of determining in Step S405 that the executed task is a reference task, the task management module 131 stores a first flag, which indicates that the task for the reference work was diverted, in the work area 112 in association with the identification information on the analysis work including the diverted task.

In the third embodiment, the processing to be executed by the main processing module 121 and the processing to be executed by the work search module 132 are partially different from those in the first embodiment.

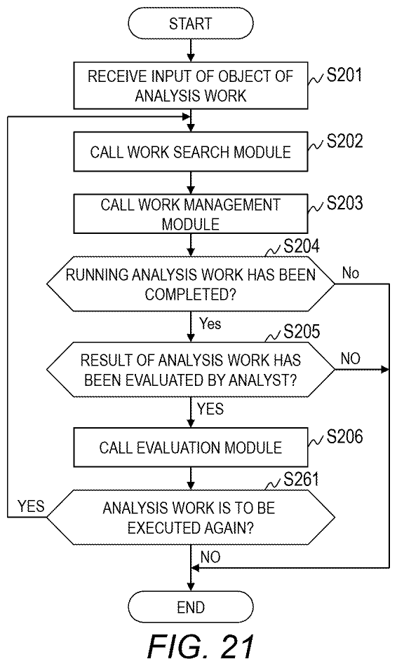

FIG. 21 is a flow chart for illustrating an example of processing to be executed by the main processing module 121 in the third embodiment.

The processing from Step S201 to Step S206 is the same processing as that in the first embodiment. After the processing of Step S206 is executed, the main processing module 121 determines whether or not to execute the analysis work again based on the evaluation obtained by the analyst for the result of the new analysis work (Step S261).

For example, in a case where the evaluation obtained for the result of the new analysis work is not “round”, the main processing module 121 determines that the analysis work is to be executed again. In addition, in a case where the evaluation obtained for the result of the currently executed analysis work becomes lower than the evaluation obtained for the result of the previously executed analysis work, the main processing module 121 determines that the analysis work is to be executed again.

In a case of determining that the analysis work is not to be executed again, the main processing module 121 brings the processing to an end.

In a case of determining that the analysis work is to be executed again, the main processing module 121 stores a second flag, which indicates that the analysis work is to be executed again, in the work area 112, and returns to Step S202.

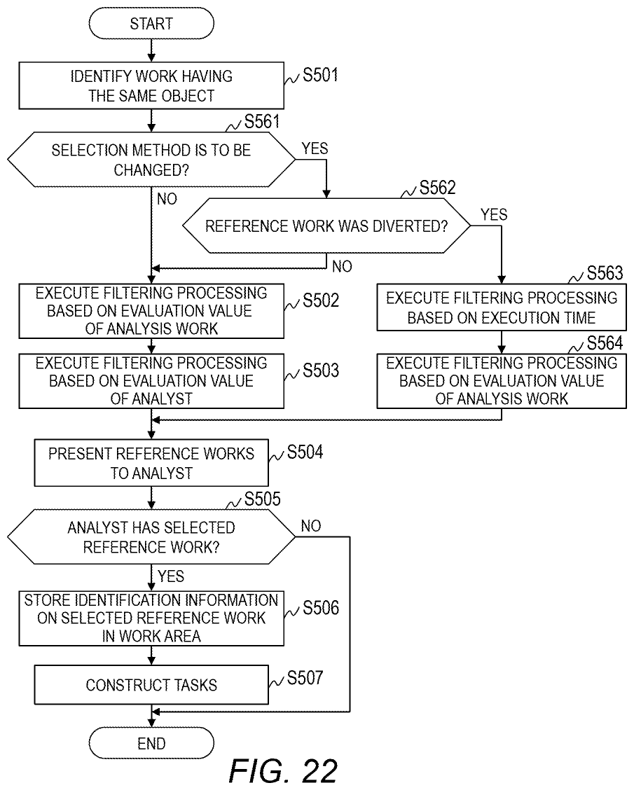

FIG. 22 is a flow chart for illustrating an example of processing to be executed by the work search module 132 in the third embodiment.

After executing the processing of Step S501, the work search module 132 determines whether or not to change the selection method (Step S561).

Specifically, the work search module 132 determines whether or not the second flag is stored in the work area 112. In a case where the second flag is stored in the work area 112, the work search module 132 determines that the selection method is to be changed.

In a case of determining that the selection method is not to be changed, the work search module 132 advances to Step S502.

In a case of determining that the selection method is to be changed, the work search module 132 determines whether or not the reference work was diverted in the previous analysis work (Step S562).

Specifically, the work search module 132 determines whether or not the first flag is stored in the work area 112. In a case where the first flag is stored in the work area 112, the work search module 132 determines that the reference work was diverted in the previous analysis work.

In a case of determining that the reference work was not diverted in the previous analysis work, the work search module 132 deletes the first flag from the work area 112, and then advances to Step S502.

In a case of determining that the reference work was diverted in the previous analysis work, the work search module 132 executes filtering processing based on an execution time (Step S563). Specifically, the following processing is executed.

(Step S563-1) The work search module 132 refers to the task management information 143 to search for an entry in which the value of the work ID 501 matches the identification information on the analysis work associated with the first flag stored in the work area 112. The work search module 132 identifies the final task for the analysis work based on the procedural step 503 of the retrieved entry.

(Step S563-2) The work search module 132 refers to the task management information 143 to identify an analysis work having the final task matching the identified final task.

(Step S563-3) The work search module 132 refers to the work management information 142 to search for an entry corresponding to the identified analysis work. The work search module 132 obtains the completion date and time 406 of the retrieved entry, and identifies the most recent completion date and time.

(Step S563-4) The work search module 132 deletes, from the work list, the analysis work executed before the identified completion date and time based on the completion date and time 406 of each of the analysis works registered in the work list. The work search module 132 deletes, from the work area 112, the first flag, the second flag, and the identification information on the analysis work associated with the second flag. The processing of Step S563 has been described above.

Subsequently, the work search module 132 executes the filtering processing based on the evaluation value of the analysis work (Step S564), and then advances to Step S504. The processing of Step S564 is the same as the processing of Step S502.

According to the third embodiment, the analysis work having the most recent execution date and time can be selected as the reference work.

It should be noted that the following processing may be performed. That is, the computer 100 first executes the filtering processing based on the evaluation value of the analysis work. In a case where the result of the analysis work executed with reference to the combination of tasks presented based on the relevant filtering processing is poor, the computer 100 executes another kind of filtering processing based on any one of the evaluation value of the analyst, the similarity degree of the input data, and the execution time.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, Python and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer system, which is configured to support a work formed of a combination of a plurality of tasks so as to be executed in order to achieve a predetermined object,
the computer system comprising at least one computer including:
a processor; and
a storage device coupled to the processor,
the computer system being configured to manage work management information for storing a plurality of logs each including identification information on a work, an object of the work, a combination of tasks for the work, and evaluation information indicating an evaluation obtained by a user for a result of the work,
the at least one computer being configured to:
obtain, in a case where a new work is to be executed, at least one of the plurality of logs including the same object as an object of the new work;
calculate a first evaluation value of the work corresponding to the at least one of the plurality of logs based on the evaluation information included in the at least one of the plurality of logs;
select a combination of tasks recommended for the new work from among combinations of tasks included in the at least one of the plurality of logs, based on the first evaluation value; and
present the selected combination of tasks to a user of the new work.

2. The computer system according to claim 1, wherein the at least one computer is configured to:
calculate a first score of the work corresponding to each of the plurality of logs based on the evaluation information included in the each of the plurality of logs;
select a target log from among a plurality of obtained logs including the same object as the object of the new work;
calculate a second score of each task of the combination of tasks included in the target log based on the first score of the work corresponding to the target log and the first score of a work diverting a part of the combination of tasks included in the target log; and
calculate the first evaluation value of the work corresponding to each of the plurality of obtained logs based on the second scores of the each of the plurality of obtained logs.

3. The computer system according to claim 2,
wherein the plurality of logs each include information on a user who has executed the work, and
wherein the at least one computer is configured to:
select a target log from among the plurality of obtained logs;
calculate a second evaluation value of the user who has executed the work corresponding to the target log based on the first score of each of the plurality of obtained logs corresponding to the work diverting the part of the combination of tasks included in the target log, and manage the second evaluation value in association with the target log; and
select a combination of tasks recommended for the new work from among the combinations of tasks included in the plurality of obtained logs, based on the first evaluation value and the second evaluation value.

4. The computer system according to claim 2,
wherein the plurality of logs each include information relating to input data on the work, and
wherein the at least one computer is configured to:
determine similarity between the input data on the work corresponding to each of the plurality of obtained logs and the input data on the new work; and
select a combination of tasks recommended for the new work from among the combinations of tasks included in the plurality of obtained logs, based on the first evaluation value and a result of the determination of the similarity.

5. The computer system according to claim 2,
wherein the plurality of logs each include a completion time of the work, and
wherein the at least one computer is configured to select a combination of tasks recommended for the new work from among the combinations of tasks included in the plurality of obtained logs, based on the first evaluation value and the completion time of the work.

6. The computer system according to claim 5, wherein the at least one computer is configured to:
select a combination of tasks recommended for the new work from among the combinations of tasks included in the plurality of obtained logs, based on the first evaluation value;
determine whether the new work is required to be executed again based on a result of the new work executed based on the selected combination of tasks; and
select, in a case of determining that the new work is required to be executed again, a combination of tasks recommended for the new work from among the combinations of tasks included in the plurality of obtained logs, based on the first evaluation value and the completion time of the work.

7. A work support method to be executed by a computer system to support a work formed of a combination of a plurality of tasks so as to be executed in order to achieve a predetermined object,
the computer system including at least one computer having a processor and a storage device coupled to the processor,
the computer system being configured to manage work management information for storing a plurality of logs each including identification information on a work, an object of the work, a combination of tasks for the work, and evaluation information indicating an evaluation obtained by a user for a result of the work,
the work support method including:
a first step of obtaining, by the at least one computer, in a case where a new work is to be executed, at least one of the plurality of logs including the same object as an object of the new work;
a second step of calculating, by the at least one computer, a first evaluation value of the work corresponding to the at least one of the plurality of logs based on the evaluation information included in the at least one of the plurality of logs;
a third step of selecting, by the at least one computer, a combination of tasks recommended for the new work from among combinations of tasks included in the at least one of the plurality of logs, based on the first evaluation value; and
a fourth step of presenting, by the at least one computer, the selected combination of tasks to the user of the new work.

8. The work support method according to claim 7, further including:
calculating, by the at least one computer, a first score of the work corresponding to each of the plurality of logs based on the evaluation information included in the each of the plurality of logs;
selecting, by the at least one computer, a target log from among a plurality of obtained logs including the same object as the object of the new work; and
calculating, by the at least one computer, a second score of each task of the combination of tasks included in the target log based on the first score of the work corresponding to the target log and the first score of a work diverting a part of the combination of tasks included in the target log,
wherein the second step includes calculating, by the at least one computer, the first evaluation value of the work corresponding to each of the plurality of obtained logs based on the second scores of the each of the plurality of obtained logs.

9. The work support method according to claim 8,
wherein the plurality of logs each include information on a user who has executed the work, and
wherein the work support method further includes:
selecting, by the at least one computer, a target log from among the plurality of obtained logs; and
calculating, by the at least one computer, a second evaluation value of the user who has executed the work corresponding to the target log based on the first score of each of the logs corresponding to the work diverting the part of the combination of tasks included in the target log, and managing the second evaluation value in association with the target log, and
wherein the third step includes selecting, by the at least one computer, a combination of tasks recommended for the new work from among the combinations of tasks included in the plurality of obtained logs, based on the first evaluation value and the second evaluation value.

10. The work support method according to claim 8,
wherein the plurality of logs each include information relating to input data on the work, and
wherein the third step includes:
determining, by the at least one computer, similarity between the input data on the work corresponding to each of the plurality of obtained logs and the input data on the new work; and
selecting, by the at least one computer, a combination of tasks recommended for the new work from among the combinations of tasks included in the plurality of obtained logs, based on the first evaluation value and a result of the determination of the similarity.

11. The work support method according to claim 8,
wherein the plurality of logs each include a completion time of the work, and
wherein the third step includes selecting, by the at least one computer, a combination of tasks recommended for the new work from among the combinations of tasks included in the plurality of obtained logs, based on the first evaluation value and the completion time of the work.

12. The work support method according to claim 11,
wherein the third step includes selecting, by the at least one computer, a combination of tasks recommended for the new work from among the combinations of tasks included in the plurality of obtained logs based on the first evaluation value, and
wherein the work support method further includes:
determining, by the at least one computer, whether the new work is required to be executed again based on a result of the new work executed based on the selected combination of tasks; and
selecting, by the at least one computer, in a case of determining that the new work is required to be executed again, a combination of tasks recommended for the new work from among the combinations of tasks included in the plurality of obtained logs, based on the first evaluation value and the completion time of the work.
